(19) United States
(12) Patent Application Publication
(10) Pub. No.: US 2013/0038610 A1
(43) Pub. Date: Feb. 14, 2013

(54) IMAGE DISPLAY APPARATUS, IMAGE DISPLAY SYSTEM, AND METHOD FOR DRIVING IMAGE DISPLAY APPARATUS

(71) Applicants: Takahiko Origuchi, Osaka (JP); Mitsuhiro Kasahara, Osaka (JP)

(72) Inventors: Takahiko Origuchi, Osaka (JP); Mitsuhiro Kasahara, Osaka (JP)

(73) Assignee: PANASONIC CORPORATION, Osaka (JP)

(21) Appl. No.: 13/643,764

(22) PCT Filed: Jun. 29, 2011
(86) PCT No.: PCT/JP2011/003700

§ 371 Date: Oct. 26, 2012

(30) Foreign Application Priority Data
Jul. 1, 2010 (JP) 2010-150718

(51) Int. Cl. G06T 15/00

(52) U.S. Cl. 345/419

(57) ABSTRACT

A user who views a display image through shutter glasses (50) is prevented from sensing illumination flicker. Plasma display apparatus (40) as an image display apparatus includes plasma display panel (10) as an image display section and a driver circuit. The driver circuit includes control signal generation circuit (45) for generating a shutter opening/closing timing signal, illumination light frequency detecting circuit (48) for detecting the blinking cycle of illumination light as an illumination frequency, and video frequency converting circuit (49) for altering a field frequency of the 3D image signal. The shutter opening/closing timing signal has a right-eye timing signal and a left-eye timing signal. In response to the illumination frequency detected by illumination light frequency detecting circuit (48), video frequency converting circuit (49) alters the field frequency of the 3D image signal and control signal generation circuit (45) alters the frequency of the shutter opening/closing timing signal.

### TECHNICAL FIELD

The present invention relates to an image display apparatus, an image display system, a driving method of an image display apparatus that allow three-dimensional view using shutter glasses of a three-dimensional image formed of a right-eye image and left-eye image that are alternately displayed on the image display panel.

### BACKGROUND ART

A television apparatus and monitor apparatus using a liquid crystal display panel or plasma display panel have recently become widespread as thin image display apparatuses. An alternating-current surface discharge type panel typical as a plasma display panel (hereinafter referred to as “panel”) has many discharge cells between a front substrate and a rear substrate that are faced to each other. The front substrate has the following elements:
a plurality of display electrode pairs disposed in parallel on a front glass substrate; and
a dielectric layer and a protective layer disposed so as to cover the display electrode pairs.
   Here, each display electrode pair is formed of a pair of scan electrode and sustain electrode.

The rear substrate has the following elements:
a plurality of data electrodes disposed in parallel on a rear glass substrate;
a dielectric layer disposed so as to cover the data electrodes;
a plurality of barrier ribs disposed on the dielectric layer in parallel with the data electrodes; and
phosphor layers disposed on the surface of the dielectric layer and on side surfaces of the barrier ribs.

The front substrate and rear substrate are faced to each other so that the display electrode pairs and the data electrodes three-dimensionally intersect, and are sealed. Discharge gas containing xenon with a partial pressure ratio of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color image display.

A subfield method is generally used as a method of driving the panel. In this subfield method, one field is divided into a plurality of subfields, and light is emitted or light is not emitted in each discharge cell in each subfield, thereby performing gradation display. Each subfield has an initializing period, an address period, and a sustain period.

In the initializing period, an initializing operation of applying an initializing waveform to each scan electrode and causing initializing discharge in each discharge cell is performed. Thus, wall charge required for a subsequent address operation is formed in each discharge cell, and a priming particle (an excitation particle for causing discharge) for stably causing address discharge is generated.

In the address period, a scan pulse is sequentially applied to scan electrodes, and an address pulse is selectively applied to data electrodes based on an image signal to be displayed. Thus, address discharge is caused between the scan electrode and the data electrode of the discharge cell to emit light, thereby producing wall charge in the discharge cell (hereinafter, this operation is also collectively referred to as “address”).

In a sustain period, as many sustain pulses as a number based on the luminance weight determined for each subfield are alternately applied to the display electrode pairs formed of the scan electrodes and the sustain electrodes. Thus, sustain discharge is caused in the discharge cell having undergone address discharge, thereby emitting light in the phosphor layer of this discharge cell (hereinafter, light emission by sustain discharge in a discharge cell is referred to as “lighting”, and no light emission is referred to as “no-lighting”). Thus, light is emitted in each discharge cell at a luminance corresponding to the luminance weight. Thus, light is emitted at a luminance corresponding to the gradation value of an image signal in each discharge cell of the panel, and an image is displayed on the image display region of the panel.

One of important factors for improving the image display quality on the panel is improvement in contrast. As one of subfield methods, a driving method for improving the contrast ratio by minimizing light emission that is not related to the gradation display is disclosed.

In this driving method, in the initializing period of one of a plurality of subfields constituting one field, an initializing operation of causing initializing discharge in all discharge cells is performed. In the initializing periods of other subfields, an initializing operation of selectively causing initializing discharge in the discharge cell that has undergone sustain discharge in the sustain period of the immediately preceding subfield is performed.

The luminance (hereinafter, referred to as “luminance of black level”) in a black displaying region that does not cause sustain discharge is varied by light emission that is not related to the image display. For example, the light emission is caused by initializing discharge. In the above-mentioned driving method, the light emission in the black displaying region is only feeble light emission when the initializing discharge is caused in all discharge cells. As a result, the luminance of black level can be reduced and an image of sharp contrast can be displayed (for example, Patent Literature 1).

A luminaire using a fluorescent light widespread for household use, generally, repeats blinking at a frequency corresponding to that of an alternating current (AC) power supply used as a power source. Some luminaries repeat blinking at a frequency twice that of the alternating current power supply, for example. When the AC power supply used as the power source has a frequency of 50 Hz, such a luminaire repeats blinking at a frequency of 100 Hz, two times 50 Hz. When the AC power supply has a frequency of 60 Hz, the luminaire repeats blinking at a frequency of 120 Hz, two times 60 Hz. Hereinafter, the repetition of such blinking is referred to as “illumination frequency”.

The number of images (the number of fields) displayed per second on an image display apparatus depends on not the frequency of the AC power supply used as the power source but an image signal. Hereinafter, the number of fields displayed per second is referred to as “field frequency”. There are various image signals whose field frequencies are 60 Hz and 50 Hz, for example. Therefore, even when the frequency of the AC power supply used as the power source is 50 Hz, the image display apparatus displays 60 images (fields) per second, or images of integral multiples of 60, when the field frequency of an image signal is 60 Hz.

At this time, in a display apparatus using external light as a light source (for example, a display apparatus using a reflection liquid crystal display panel), fluctuation (flicker) can occur in a display image. That is because the timing of blinking of illumination light shifts from the timing of switching the field of the image signal in response to the frequency difference. Thus, a technology is disclosed which reduces the fluctuation by detecting the illumination frequency through detection of variation in brightness of the external light and by altering the field frequency of the image signal based on the detected illumination frequency (for example, Patent Literature 2 and Patent Literature 3).

A technology is also disclosed which reduces the fluctuation caused by interference of the illumination light with the image displayed on a liquid crystal display panel by altering the field frequency of the image signal based on the frequency of the AC power supply used as the power source (for example, Patent Literature 4).

A technology is also disclosed where fluctuation caused by interference of the illumination light with the image displayed on an image display section is reduced by detecting the illumination frequency through detection of variation in brightness of the external light and by altering the field frequency of the image signal based on the detected illumination frequency (for example, Patent Literature 5).

In a plasma display apparatus, the panel emits light by itself and an image is displayed on the panel by the subfield method, so that the above-mentioned fluctuation hardly occurs. Also in a liquid crystal display apparatus having, as a backlight (light source), a fluorescent light or a light emission diode (LED) for repeating blinking at a high speed with an inverter or the like, the flicker hardly occurs.

Recently, as a three-dimensional image (hereinafter referred to as “3D image”) display apparatus for displaying a 3D image capable of being viewed three-dimensionally, a plasma display apparatus, a liquid crystal display apparatus, or an electroluminescence (EL) display apparatus has been studied.

As one of methods of three-dimensionally viewing a 3D image using a plasma display apparatus, a method is disclosed in which a plurality of subfields are classified into a subfield group for displaying right-eye images and a subfield group for displaying left-eye images (for example, Patent Literature 6).

One 3D image is constituted by one right-eye image and one left-eye image. When the 3D image is displayed on the 3D image display apparatus, the right-eye image and left-eye image are alternately displayed on the image display surface.

When a 3D image is displayed, a half the image displayed on the image display surface per unit time (for example, one second) is a right-eye image and the remaining half is a left-eye image. Therefore, the number of 3D images displayed on the image display surface per second is a half the field frequency (the number of fields displayed per second). When the number of images displayed on the image display surface per unit time is small, fluctuation in image called flicker is apt to be viewed.

When an image other than a 3D image, namely a normal image (hereinafter referred to as “2D image”) having no differentiation between right-eye and left-eye, is displayed on the panel, 60 images are displayed on the panel per second when the field frequency is 60 Hz, for example. Therefore, in order to display as many 3D images as 2D images on the panel per unit time (for example, 60 images per second) to reduce the flicker, the field frequency of the 3D image signal must be set at twice (for example, 120 Hz) that of the 2D image signal.

When a user views the 3D image displayed on the 3D image display apparatus, the user uses special glasses called shutter glasses.

The shutter glasses have a right-eye shutter and a left-eye shutter, and the right-eye and left-eye shutters alternately open and close in response to a control signal for controlling the opening/closing of the shutters. The control signal is supplied from the 3D image display apparatus to the shutter glasses so that the right-eye and left-eye shutters alternately open and close synchronously with each of a field for displaying the right-eye image and a field for displaying the left-eye image.

In response to the control signal, the shutter glasses open the right-eye shutter (visible light is transmitted) and close the left-eye shutter (visible light is blocked) in a period in which the right-eye image is displayed on the image display surface. The shutter glasses open the left-eye shutter and close the right-eye shutter in a period in which the left-eye image is displayed. Thus, the user who views the 3D image through the shutter glasses can observe the right-eye image only with the right eye and the left-eye image only with the left eye, and can three-dimensionally view the 3D image displayed on the image display surface.

However, the user who uses the shutter glasses views, through them, not only the 3D image displayed on the image display surface but also illumination light generated by the luminaire.

When a 3D image signal of a field frequency of 120 Hz is displayed on the 3D image display apparatus, 120 images are displayed per second on the 3D image display apparatus. Therefore, the shutter glasses used for viewing the image repeat the opening/closing operation of the right-eye and left-eye shutters at a frequency of 60 Hz in a state where phases thereof are shifted from each other by 180°.

For example, when the 3D image display apparatus is installed under a luminaire of an illumination frequency of 120 Hz and a user views a 3D image of 120 Hz, the timing of opening/closing of the shutters of the shutter glasses is substantially synchronized with the timing of blinking of the illumination light. Therefore, the possibility that a user who views the 3D image through the shutter glasses feels as if the brightness of the illumination varies is low, and it is considered that the user can view the 3D image especially without feeling discomfort.

When the 3D image display apparatus is installed under a luminaire of a illumination frequency of 100 Hz and a user views a 3D image of 120 Hz, the illumination frequency is 100 Hz but the frequency of the shutter opening/closing operation of the shutter glasses is 60 Hz. Therefore, the timing of opening/closing of the shutters of the shutter glasses is shifted from the timing of blinking of the illumination light in response to the difference between their cycles. As a result, the brightness of the illumination light that enters the eyes of the user in the open state of the shutters varies with time. Therefore, the user who views the 3D image through the shutter glasses can feel as if the brightness of the illumination varies with time. Hereinafter, such variation in brightness is referred to as “illumination flicker”.

As the screen of the image display surface has been enlarged and the definition has been enhanced recently, further quality improvement in an image display apparatus has been demanded and high quality has been demanded also in a 3D image display apparatus. Therefore, for a user who views the 3D image through the shutter glasses, occurrence of illumination flicker is not desired.

### CITATION LIST

### Patent Literature

PLT 1 Unexamined Japanese Patent Publication No. 2000-242224
PLT 2 Unexamined Japanese Patent Publication No. 2001-306033
PLT 3 Unexamined Japanese Patent Publication No. 2008-139753
PLT 4 Unexamined Japanese Patent Publication No. 2002-202772
PLT 5 Unexamined Japanese Patent Publication No. H09-198002
PLT 6 Unexamined Japanese Patent Publication No. 2000-112428

### SUMMARY OF THE INVENTION

The present invention provides an image display apparatus including an image display section and a driver circuit. The driver circuit displays a 3D image on the image display section by alternately repeating a right-eye field for displaying a right-eye image signal and a left-eye field for displaying a left-eye image signal based on a 3D image signal having the right-eye image signal and the left-eye image signal. The driver circuit includes the following elements:
a control signal generation circuit for generating a shutter opening/closing timing signal;
an illumination light frequency detecting circuit for detecting the cycle of blinking of illumination light as the illumination frequency; and
a video frequency converting circuit for altering the field frequency of the 3D image signal.
   Here, the shutter opening/closing timing signal includes the following signals:
a right-eye timing signal that becomes ON when a right-eye field is displayed on the image display section or becomes OFF when a left-eye field is displayed; and
a left-eye timing signal that becomes ON when a left-eye field is displayed or becomes OFF when a right-eye field is displayed.
   Then, in response to the illumination frequency detected by the illumination light frequency detecting circuit, the video frequency converting circuit alters the field frequency of the 3D image signal and the control signal generation circuit alters the frequency of the shutter opening/closing timing signal.

Thus, in the image display apparatus usable as a 3D image display apparatus, a user who views the display image through the shutter glasses can be prevented from sensing illumination flicker.

When the illumination frequency detected by the illumination light frequency detecting circuit is different from the field frequency of the 3D image signal, the driver circuit of the image display apparatus of the present invention alters the field frequency of the 3D image signal so that the field frequency of the 3D image signal is equal to the illumination frequency, and alters the frequency of the shutter opening/closing timing signal in response to the alteration of the field frequency of the 3D image signal.

The driver circuit of the image display apparatus of the present invention receives a 3D image signal and a 2D image signal that has no differentiation between the right-eye image signal and left-eye image signal. Only when the 3D image signal is received, the driver circuit alters the field frequency and the frequency of the shutter opening/closing timing signal in response to the illumination frequency.

The driver circuit of the image display apparatus of the present invention may include an average illuminance detecting section for detecting the average illuminance of the illumination light. When the average illuminance detected by the average illuminance detecting section is lower than an average illuminance threshold, the video frequency converting circuit does not perform the alteration of the field frequency responsive to the illumination frequency, and the control signal generation circuit does not perform the frequency alteration of the shutter opening/closing timing signal.

The driver circuit of the image display apparatus of the present invention may include a minimum illuminance detecting section for detecting the minimum illuminance of the illumination light. When the minimum illuminance detected by the minimum illuminance detecting section is a minimum illuminance threshold or higher, the video frequency converting circuit does not perform the alteration of the field frequency responsive to the illumination frequency, and the control signal generation circuit does not perform the frequency alteration of the shutter opening/closing timing signal.

The present invention provides a driving method of an image display apparatus. The image display apparatus includes an image display section and a driver circuit. The driver circuit displays a 3D image on the image display section by alternately repeating a right-eye field for displaying a right-eye image signal and a left-eye field for displaying a left-eye image signal based on a 3D image signal having the right-eye image signal and the left-eye image signal. The image display apparatus generates a shutter opening/closing timing signal including the following signals:
a right-eye timing signal that becomes ON when a right-eye field is displayed on the image display section or becomes OFF when a left-eye field is displayed; and
a left-eye timing signal that becomes ON when a left-eye field is displayed or becomes OFF when a right-eye field is displayed.
   The blinking cycle of illumination light is detected as the illumination frequency, and the field frequency of the 3D image signal and the frequency of the shutter opening/closing timing signal are altered in response to the illumination frequency.

Thus, in the image display apparatus usable as a 3D image display apparatus, a user who views a display image through shutter glasses can be prevented from sensing illumination flicker.

In the driving method of the image display apparatus of the present invention, the driver circuit receives a 3D image signal and a 2D image signal that has no differentiation between the right-eye image signal and left-eye image signal. Only when the driver circuit receives the 3D image signal, it alters the field frequency and the frequency of the shutter opening/closing timing signal in response to the illumination frequency.

In the driving method of the image display apparatus of the present invention, when average illuminance of illumination light is detected and the average illuminance is lower than an average illuminance threshold, the alteration of the field frequency and the frequency alteration of the shutter opening/closing timing signal responsive to the illumination frequency are not required.

In the driving method of the image display apparatus of the present invention, when minimum illuminance of illumination light is detected and the minimum illuminance is a minimum illuminance threshold or higher, the alteration of the field frequency and the frequency alteration of the shutter opening/closing timing signal responsive to the illumination frequency are not required.

The present invention provides an image display system including an image display apparatus and shutter glasses. The image display apparatus includes an image display section and a driver circuit. The driver circuit displays a 3D image on the image display section by alternately repeating a right-eye field for displaying a right-eye image signal and a left-eye field for displaying a left-eye image signal based on a 3D image signal having the right-eye image signal and the left-eye image signal. The driver circuit includes the following elements:
a control signal generation circuit for generating a shutter opening/closing timing signal;
an illumination light frequency detecting circuit for detecting the blinking cycle of illumination light as the illumination frequency; and
a video frequency converting circuit for altering the field frequency of the 3D image signal.
   Here, the shutter opening/closing timing signal includes the following signals:
a right-eye timing signal that becomes ON when a right-eye field is displayed on the image display section or becomes OFF when a left-eye field is displayed; and
a left-eye timing signal that becomes ON when a left-eye field is displayed or becomes OFF when a right-eye field is displayed.
   The shutter glasses have a right-eye shutter and a left-eye shutter capable of being opened or closed independently. The opening and closing of the shutters are controlled in response to the shutter opening/closing timing signal generated by the control signal generation circuit. Then, in response to the illumination frequency detected by the illumination light frequency detecting circuit, the video frequency converting circuit alters the field frequency of the 3D image signal and the control signal generation circuit alters the frequency of the shutter opening/closing timing signal. The opening and closing of the shutters of the shutter glasses are controlled in response to the shutter opening/closing timing signal whose frequency is altered.

Thus, in the image display system usable as a 3D image display apparatus, a user who views a display image through the shutter glasses can be prevented from sensing illumination flicker.

### BRIEF DESCRIPTION OF DRAWINGS

FIG. 1 is an exploded perspective view showing a structure of a panel used in a plasma display apparatus in accordance with a first exemplary embodiment of the present invention.

FIG. 2 is an electrode array diagram of the panel used in the plasma display apparatus in accordance with the first exemplary embodiment of the present invention.

FIG. 3 is a diagram for schematically showing circuit blocks of the plasma display apparatus and a plasma display system in accordance with the first exemplary embodiment of the present invention.

FIG. 4 is a diagram for schematically showing a driving voltage waveform applied to each electrode of the panel used in the plasma display apparatus in accordance with the first exemplary embodiment of the present invention.

FIG. 5 is a waveform chart for schematically showing a driving voltage waveform applied to each electrode of the panel used in the plasma display apparatus and a shutter opening/closing operation of shutter glasses in accordance with the first exemplary embodiment of the present invention.

FIG. 6 is a waveform chart for schematically showing an example of the blinking of illumination light in a luminaire for illuminating the environment in which the plasma display apparatus is installed and the shutter opening/closing operation of the shutter glasses.

FIG. 7 is a waveform chart for schematically showing an example of the blinking of illumination light in the luminaire for illuminating the environment in which the plasma display apparatus is installed and the shutter opening/closing operation of the shutter glasses.

FIG. 8 is a diagram for schematically showing the circuit block of an illuminance detecting circuit in accordance with the first exemplary embodiment of the present invention.

FIG. 9 is a diagram for schematically showing the circuit block of an illumination light frequency detecting circuit in accordance with the first exemplary embodiment of the present invention.

FIG. 10 is a diagram for schematically showing the circuit block of a video frequency converting circuit in accordance with the first exemplary embodiment of the present invention.

FIG. 11 is a diagram for schematically showing an example when a frequency converting section converts a 3D image signal of a field frequency of 120 Hz into a 3D image signal of a field frequency of 100 Hz in accordance with the first exemplary embodiment of the present invention.

FIG. 12 is a diagram for schematically showing a setting example of weighing coefficients when the frequency converting section converts a 3D image signal of a field frequency of 120 Hz into a 3D image signal of a field frequency of 100 Hz in accordance with the first exemplary embodiment of the present invention.

FIG. 13 is a diagram for schematically showing an example of an operation when the frequency converting section generates one right-eye interpolation image from two continuous right-eye images in accordance with the first exemplary embodiment of the present invention.

FIG. 14 is a diagram for schematically showing an example when the frequency converting section converts a 3D image signal of a field frequency of 100 Hz into a 3D image signal of a field frequency of 120 Hz in accordance with the first exemplary embodiment of the present invention.

FIG. 15 is a diagram for schematically showing a setting example of weighing coefficients when the frequency converting section converts a 3D image signal of a field frequency of 100 Hz into a 3D image signal of a field frequency of 120 Hz in accordance with the first exemplary embodiment of the present invention.

FIG. 16 is a diagram for schematically showing circuit blocks of a plasma display apparatus and a plasma display system in accordance with a second exemplary embodiment of the present invention.

FIG. 17 is a diagram for schematically showing an example of the circuit block of a video frequency converting circuit in accordance with the second exemplary embodiment of the present invention.

FIG. 18 is a diagram for schematically showing another example of the circuit block of the video frequency converting circuit in accordance with the second exemplary embodiment of the present invention.

### DESCRIPTION OF EMBODIMENTS

An image display apparatus and an image display system in accordance with exemplary embodiments of the present invention will be described hereinafter.

A plasma display apparatus as the image display apparatus is described as an example hereinafter, but the image display apparatus of the present invention is not limited to the plasma display apparatus. An image display apparatus of the present invention can produce a similar effect using a configuration similar to the following one as long as the image display apparatus such as a liquid crystal display apparatus or an EL display apparatus can display a 3D image on an image display surface by alternately displaying a right-eye image and a left-eye image.

A plasma display apparatus and plasma display system as an example of the exemplary embodiments of the present invention will be described hereinafter with reference to the accompanying drawings.

### First Exemplary Embodiment

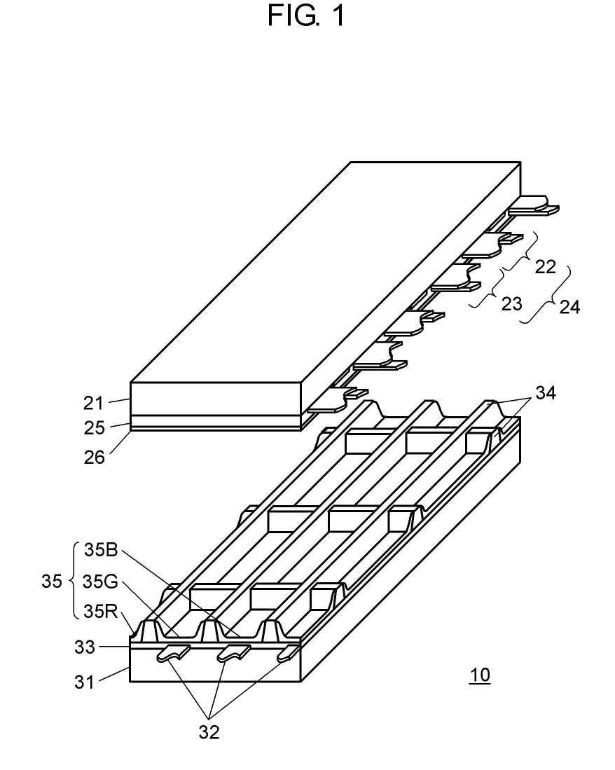

FIG. 1 is an exploded perspective view showing the structure of panel 10 used in a plasma display apparatus in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover scan electrodes 22 and sustain electrodes 23, and protective layer 26 is formed on dielectric layer 25.

Protective layer 26 is made of a material mainly made of magnesium oxide (MgO) in order to reduce the discharge start voltage in a discharge cell. The magnesium oxide has been used as a material of a panel, and has a large secondary electron emission coefficient and high durability when neon (Ne) gas and xenon (Xe) gas are filled.

A plurality of data electrodes 32 is formed on rear substrate 31, dielectric layer 33 is formed so as to cover data electrodes 32, and mesh barrier ribs 34 are formed on dielectric layer 33. Phosphor layer 35R for emitting light of red color (R), phosphor layer 35G for emitting light of green color (G), and phosphor layer 35B for emitting light of blue color (B) are formed on the side surfaces of barrier ribs 34 and on dielectric layer 33. Hereinafter, phosphor layer 35R, phosphor layer 35G, and phosphor layer 35B are collectively denoted as phosphor layers 35.

In the present exemplary embodiment, BaMgAl₁₀O₁₇:Eu is used as the blue phosphor, Zn₂SiO₄:Mn is used as the green phosphor, and (Y,Gd)BO₃:Eu is used as the red phosphor. In the present invention, the phosphors forming phosphor layers 35 are not limited to the above-mentioned phosphors. The time constant representing the time required for attenuation of the afterglow of each phosphor depends on the phosphor material. The time constant of the blue phosphor is 1 msec or shorter, that of the green phosphor is about 2 to 5 msec, and that of the red phosphor is about 3 to 4 msec. In the present exemplary embodiment, for example, the time constant of phosphor layer 35B is about 0.1 msec, and those of phosphor layer 35G and phosphor layer 35R are about 3 msec. Each time constant is defined as the time period after the completion of discharge until the afterglow attenuates to about 10% of the emission luminance (peak luminance) during discharge.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example.

The discharge space is partitioned into a plurality of sections by barrier ribs 34. Discharge cells are formed in the intersecting parts of display electrode pairs 24 and data electrodes 32.

Then, discharge is caused in the discharge cells, and light is emitted (lighting in the discharge cells) in phosphor layers 35 of them, thereby displaying a color image on panel 10.

In panel 10, one pixel is formed of three consecutive discharge cells arranged in the extending direction of display electrode pairs 24. The three discharge cells are a discharge cell for emitting light of red color (R), a discharge cell for emitting light of green color (G), and a discharge cell for emitting light of blue color (B).

The structure of panel 10 is not limited to the above-mentioned one, but may be a structure having striped barrier ribs, for example.

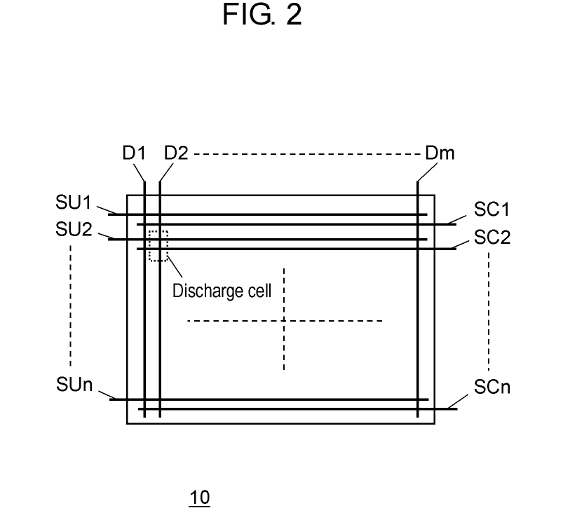

FIG. 2 is an electrode array diagram of panel 10 used in the plasma display apparatus in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended horizontally (row direction), and m data electrode D1 through data electrode Dm (data electrodes 32 in FIG. 1) extended vertically (column direction). A discharge cell is formed in the part where a pair of scan electrode SCi (i is 1 through n) and sustain electrode SUi intersect with one data electrode Dj (j is 1 through m). In other words, on one display electrode pair 24, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3 and n is 1080.

A red phosphor is applied as phosphor layer 35R to a discharge cell having data electrode Dp (p=3×q−2: q is an integer other than 0 and is m/3 or smaller), a green phosphor is applied as phosphor layer 35G to a discharge cell having data electrode Dp+1, and a blue phosphor is applied as phosphor layer 35B to a discharge cell having data electrode Dp+2.

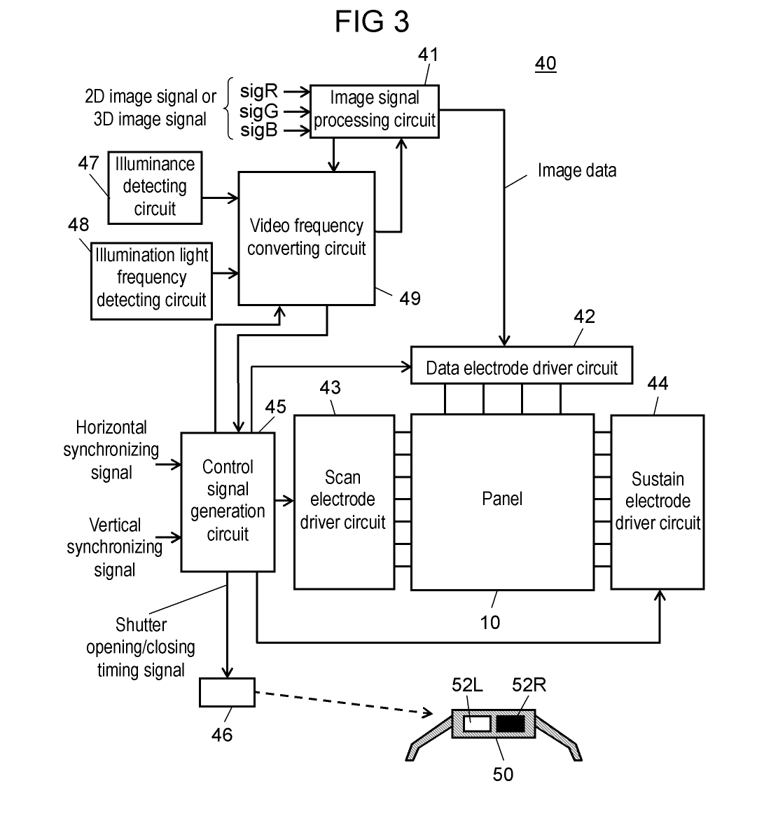

FIG. 3 is a diagram for schematically showing circuit blocks of plasma display apparatus 40 and a plasma display system in accordance with the first exemplary embodiment of the present invention. The plasma display system of the first exemplary embodiment includes, as components, plasma display apparatus 40 and shutter glasses 50.

FIG. 3 does not show the luminaire for illuminating plasma display apparatus 40, but plasma display apparatus 40 of the present exemplary embodiment performs an operation responsive to the illumination frequency of the illumination light generated by the luminaire.

Plasma display apparatus 40 as the image display apparatus includes panel 10 as the image display section and a driver circuit for driving panel 10.

The driver circuit has the following elements:
image signal processing circuit 41;
data electrode driver circuit 42;
scan electrode driver circuit 43;
sustain electrode driver circuit 44;
control signal generation circuit 45;
illuminance detecting circuit 47;
illumination light frequency detecting circuit 48;
video frequency converting circuit 49; and
a power supply circuit (not shown) for supplying power required for each circuit block.

The driver circuit drives panel 10 by one of 3D drive for displaying a 3D image on panel 10 by alternately repeating a right-eye field and a left-eye field based on a 3D image signal and 2D drive for displaying a 2D image on panel 10 based on a 2D image signal that has no differentiation between the right-eye and left-eye. Plasma display apparatus 40 also includes timing signal output section 46. Timing signal output section 46 outputs, to shutter glasses 50, a shutter opening/closing timing signal for controlling the opening/closing of the shutters of shutter glasses 50 used by a user. Shutter glasses 50 are used by a user when a 3D image is displayed on panel 10, and the user can three-dimensionally view the 3D image by viewing the 3D image displayed on panel 10 through shutter glasses 50.

Image signal processing circuit 41 receives a 2D image signal or 3D image signal, and assigns a gradation value to each discharge cell based on an input image signal. Then, image signal processing circuit 41 converts the gradation value into image data indicating light emission and no light emission in each subfield (light emission and no light emission are made to correspond to digital signals, “1” and “0”). In other words, image signal processing circuit 41 converts the image signal in each field into image data indicating the light emission and no light emission in each subfield.

When an image signal input to image signal processing circuit 41 includes red primary color signal sigR, green primary color signal sigG, and blue primary color signal sigB, image signal processing circuit 41 assigns each gradation value of R, G, and B to each discharge cell based on primary color signal sigR, primary color signal sigG, and primary color signal sigB. When the input image signal includes a luminance signal (Y signal) and a chroma signal (C signal, R-Y signal and B-Y signal, or u signal and v signal), image signal processing circuit 41 calculates primary color signal sigR, primary color signal sigG, and primary color signal sigB based on the luminance signal and chroma signal, and then assigns each gradation value (gradation value represented in one field) of R, G, and B to each discharge cell. Image signal processing circuit 41 converts each gradation value of R, G, and B assigned to each discharge cell into image data that indicates light emission or no light emission in each subfield.

When the input image signal is a 3D image signal for 3D vision having a right-eye image signal and a left-eye image signal, and the 3D image signal is displayed on panel 10, the right-eye image signal and left-eye image signal are alternately input to image signal processing circuit 41 in each field. Therefore, image signal processing circuit 41 converts the right-eye image signal into right-eye image data, and converts the left-eye image signal into left-eye image data.

Control signal generation circuit 45 determines which of a 2D image signal and 3D image signal is input to plasma display apparatus 40 based on an input signal. In order to display the 2D image or 3D image on panel 10, control signal generation circuit 45 generates a control signal for controlling each driver circuit based on the determination result.

Specifically, control signal generation circuit 45 determines whether the input signal to plasma display apparatus 40 is a 3D image signal or a 2D image signal based on the frequencies of the horizontal synchronizing signal and the vertical synchronizing signal of the input signal. Control signal generation circuit 45 determines that the input signal is a 2D image signal when the horizontal synchronizing signal is 33.75 kHz and the vertical synchronizing signal is 60 Hz, or determines that the input signal is a 3D image signal when the horizontal synchronizing signal is 67.5 kHz and the vertical synchronizing signal is 120 Hz, for example.

A configuration may be employed where, when a determination signal for determining the 2D image signal or 3D image signal is added to the input signal, control signal generation circuit 45 determines which of the 2D image signal and 3D image signal is input based on the determination signal.

Based on the horizontal synchronizing signal and the vertical synchronizing signal, control signal generation circuit 45 generates various control signals for controlling the operation of each circuit block. Then, control signal generation circuit 45 supplies the generated control signals to respective circuit blocks (data electrode driver circuit 42, scan electrode driver circuit 43, sustain electrode driver circuit 44, and image signal processing circuit 41).

When a 3D image is displayed on panel 10, control signal generation circuit 45 outputs, to timing signal output section 46, a shutter opening/closing timing signal for controlling the opening/closing of the shutters of shutter glasses 50. Control signal generation circuit 45 sets the shutter opening/closing timing signal at ON (“1”) when the shutters of shutter glasses 50 are opened (visible light is transmitted), and sets the shutter opening/closing timing signal at OFF (“0”) when the shutters of shutter glasses 50 are closed (visible light is blocked).

The shutter opening/closing timing signal includes the following signals:
a right-eye timing signal (right-eye shutter opening/closing timing signal) that is set at ON when the right-eye field based on the right-eye image signal of the 3D image is displayed on panel 10, and is set at OFF when the left-eye field based on the left-eye image signal is displayed; and
a left-eye timing signal (left-eye shutter opening/closing timing signal) that is set at ON when the left-eye field based on the left-eye image signal of the 3D image is displayed, and is set at OFF when the right-eye field based on the right-eye image signal is displayed.

In the present exemplary embodiment, the frequencies of the horizontal synchronizing signal and vertical synchronizing signal are not limited to the above-mentioned numerical values.

Illuminance detecting circuit 47 has a light detecting section whose generation current or resistance value varies in response to the light intensity (illuminance), and detects the brightness of the periphery of plasma display apparatus 40. Then, illuminance detecting circuit 47 outputs the detection result to video frequency converting circuit 49.

Illumination light frequency detecting circuit 48 has a light detecting section similar to that of illuminance detecting circuit 47, and detects the variation cycle of the brightness of the periphery of plasma display apparatus 40. Some luminaries using a fluorescent light widespread for household use repeat blinking in response to the frequency of the AC power supply used as a power source. Illumination light frequency detecting circuit 48 detects the repetition of the blinking of illumination light, namely “illumination frequency”. Illumination light frequency detecting circuit 48 outputs the detection result to video frequency converting circuit 49.

Video frequency converting circuit 49 alters the field frequency of the 3D image signal (the number of fields generated per second, hereinafter referred to as “video frequency”) and the frequency of the vertical synchronizing signal based on the detection result of illuminance detecting circuit 47 and the detection result of illumination light frequency detecting circuit 48. For example, when the illumination frequency detected by illumination light frequency detecting circuit 48 is 100 Hz and the field frequency of the 3D image signal and the frequency of the vertical synchronizing signal are 120 Hz, video frequency converting circuit 49 alters the field frequency of the 3D image signal and the frequency of the vertical synchronizing signal from 120 Hz to 100 Hz. When the illumination frequency detected by illumination light frequency detecting circuit 48 is 120 Hz and the field frequency of the 3D image signal and the frequency of the vertical synchronizing signal are 100 Hz, video frequency converting circuit 49 alters the field frequency of the 3D image signal and the frequency of the vertical synchronizing signal from 100 Hz to 120 Hz.

However, video frequency converting circuit 49 does not alter the image signal and vertical synchronizing signal when the illumination frequency detected by illumination light frequency detecting circuit 48 is equal to the field frequency of the 3D image signal and the frequency of the vertical synchronizing signal, and when the image displayed on panel 10 is a 2D image.

Control signal generation circuit 45 generates various control signals for controlling the operation of each circuit block based on the vertical synchronizing signal after the frequency alteration by video frequency converting circuit 49. Therefore, when the illumination frequency detected by illumination light frequency detecting circuit 48 is 100 Hz for example, control signal generation circuit 45 generates a shutter opening/closing timing signal so that each of the right and left shutters (right-eye shutter 52R and left-eye shutter 52L) of shutter glasses 50 repeats 50 opening/closing operations per second even if the field frequency of the image signal (3D image signal) input to image signal processing circuit 41 is 120 Hz. Alternatively, when the illumination frequency detected by illumination light frequency detecting circuit 48 is 120 Hz, control signal generation circuit 45 generates a shutter opening/closing timing signal so that each of the right and left shutters (right-eye shutter 52R and left-eye shutter 52L) of shutter glasses 50 repeats 60 opening/closing operations per second even if the field frequency of the image signal (3D image signal) input to image signal processing circuit 41 is 100 Hz. Thus, control signal generation circuit 45 alters the frequency of the shutter opening/closing timing signal in response to the illumination frequency detected by illumination light frequency detecting circuit 48.

Hereinafter, the shutter opening/closing timing signal generated so that each of the right and left shutters of shutter glasses 50 repeats 50 opening/closing operations per second is represented as “the frequency of the shutter opening/closing timing signal is 50 Hz”. The shutter opening/closing timing signal generated so that each of the right and left shutters of shutter glasses 50 repeats 60 opening/closing operations per second is represented as “the frequency of the shutter opening/closing timing signal is 60 Hz”.

In other words, when the illumination frequency detected by illumination light frequency detecting circuit 48 is 100 Hz, the frequency of the shutter opening/closing timing signal supplied from timing signal output section 46 to shutter glasses 50 becomes 50 Hz. When the illumination frequency detected by illumination light frequency detecting circuit 48 is 120 Hz, the frequency of the shutter opening/closing timing signal supplied from timing signal output section 46 to shutter glasses 50 becomes 60 Hz.

Thus, in the present exemplary embodiment, when there is a difference between the blinking cycle (illumination frequency) of illumination light and the field frequency of the 3D image signal, the shutter opening/closing operation of shutter glasses 50 is made to coincide with the blinking cycle of the illumination light (they are synchronized with each other). Thus, a user who views the 3D image displayed on panel 10 through shutter glasses 50 is prevented from sensing illumination flicker.

The details of illuminance detecting circuit 47, illumination light frequency detecting circuit 48, and video frequency converting circuit 49 are described later.

Scan electrode driver circuit 43 has an initializing waveform generation circuit, a sustain pulse generation circuit, and a scan pulse generation circuit (not shown in FIG. 3). Scan electrode driver circuit 43 generates a driving voltage waveform based on a control signal supplied from control signal generation circuit 45, and applies it to each of scan electrode SC1 through scan electrode SCn. The initializing waveform generation circuit generates an initializing waveform to be applied to scan electrode SC1 through scan electrode SCn based on the control signal in the initializing period. The sustain pulse generation circuit generates a sustain pulse to be applied to scan electrode SC1 through scan electrode SCn based on the control signal in the sustain period. The scan pulse generation circuit has a plurality of scan electrode driver ICs (scan ICs), and generates a scan pulse to be applied to scan electrode SC1 through scan electrode SCn based on the control signal in the address period.

Sustain electrode driver circuit 44 has a sustain pulse generation circuit and a circuit (not shown in FIG. 3) for generating voltage Ve1 and voltage Ve2. Sustain electrode driver circuit 44 generates a driving voltage waveform based on the control signal supplied from control signal generation circuit 45, and applies it to each of sustain electrode SU1 through sustain electrode SUn. Sustain electrode driver circuit 44 generates a sustain pulse based on the control signal and applies it to each of sustain electrode SU1 through sustain electrode SUn in the sustain period.

Data electrode driver circuit 42 converts image data based on the 2D image signal or data of each subfield that constitutes right-eye image data and left-eye image data based on the 3D image signal into a signal corresponding to each of data electrode D1 through data electrode Dm. Data electrode driver circuit 42 drives each of data electrode D1 through data electrode Dm based on the converted signal and the control signal supplied from control signal generation circuit 45. Data electrode driver circuit 42 generates an address pulse and applies it to each of data electrode D1 through data electrode Dm in the address period.

Timing signal output section 46 has a light emitting element such as a light emitting diode (LED). Timing signal output section 46 converts a shutter opening/closing timing signal into an infrared signal, for example, and supplies it to shutter glasses 50.

Shutter glasses 50 include right-eye shutter 52R, left-eye shutter 52L, and a signal receiving section (not shown) for receiving a signal (e.g. infrared signal) output from timing signal output section 46. Right-eye shutter 52R and left-eye shutter 52L can be independently opened or closed. Shutter glasses 50 open or close right-eye shutter 52R and left-eye shutter 52L based on the shutter opening/closing timing signal supplied from timing signal output section 46.

Right-eye shutter 52R is opened (visible light is transmitted) when the right-eye timing signal is in the ON state, or is closed (visible light is blocked) when the signal is in the OFF state. Left-eye shutter 52L is opened (visible light is transmitted) when the left-eye timing signal is in the ON state, or is closed (visible light is blocked) when the signal is in the OFF state.

Right-eye shutter 52R and left-eye shutter 52L can be made of liquid crystal, for example. However, the material of the shutters of the present invention is not limited to the liquid crystal, but may be any material as long as the material allows high speed switching between the blocking and transmission of visible light.

In the present exemplary embodiment, based on the illumination frequency detected by illumination light frequency detecting circuit 48, the field frequency of the 3D image signal is altered and the shutter opening/closing timing signal supplied from timing signal output section 46 to shutter glasses 50 is altered, as discussed above.

Therefore, when the illumination frequency detected by illumination light frequency detecting circuit 48 is 100 Hz, the 3D image displayed on panel 10 becomes 100 Hz, the shutter opening/closing timing signal supplied from timing signal output section 46 to shutter glasses 50 becomes 50 Hz (or an integral multiple thereof), and each of right-eye shutter 52R and left-eye shutter 52L repeats 50 opening/closing operations per second.

Alternatively, when the illumination frequency detected by illumination light frequency detecting circuit 48 is 120 Hz, the 3D image displayed on panel 10 becomes 120 Hz, the shutter opening/closing timing signal supplied from timing signal output section 46 to shutter glasses 50 becomes 60 Hz (or an integral multiple thereof), and each of right-eye shutter 52R and left-eye shutter 52L repeats 60 opening/closing operations per second.

Thus, in the present exemplary embodiment, when there is a difference between the blinking cycle (illumination frequency) of illumination light and the field frequency of the 3D image signal, and hence time lag occurs between the opening/closing operation of the shutters of shutter glasses 50 and the blinking cycle of illumination light, a user who uses the shutter glasses is prevented from sensing illumination flicker.

Next, a driving voltage waveform and its operation for driving panel 10 are described schematically.

Plasma display apparatus 40 of the present embodiment drives panel 10 by a subfield method. In this subfield method, the plasma display apparatus divides one field into a plurality of subfields on the time axis, and sets luminance weight for each subfield. Therefore, each field has a plurality of subfields. Each subfield has an initializing period, an address period, and a sustain period.

In the initializing period, an initializing operation of causing the initializing discharge in a discharge cell and producing, on each electrode, wall charge required for address discharge in the subsequent address period is performed.

In the address period, the address operation is performed where a scan pulse is applied to scan electrodes 22, an address pulse is selectively applied to data electrodes 32, address discharge is selectively caused in a discharge cell to emit light, and wall charge for generating sustain discharge in the subsequent sustain period is produced in the discharge cell.

In the sustain period, the sustain operation is performed where as many sustain pulses as the number derived by multiplying the luminance weight set for each subfield by a predetermined proportionality constant are alternately applied to scan electrode 22 and sustain electrode 23, sustain discharge is caused in the discharge cell having undergone address discharge in the immediately preceding address period, and light is emitted in the discharge cell. This proportionality constant is luminance magnification.

The luminance weight means the ratio between the luminances displayed in respective subfields, and as many sustain pulses as the number corresponding to the luminance weight are generated in each subfield in the sustain period. Therefore, in the subfield of luminance weight “8”, light is emitted at a luminance about eight times that in the subfield of luminance weight “1”, and light is emitted at a luminance about four times that in the subfield of luminance weight “2”.

For example, when the luminance magnification is two, four sustain pulses are applied to each of scan electrode 22 and sustain electrode 23 in the sustain period of the subfield of luminance weight “2”. Therefore, the number of sustain pulses occurring in the sustain period is 8.

Therefore, various gradations can be displayed and various images can be displayed on panel 10, by selectively emitting light in each subfield by controlling the light emission or no light emission in each discharge cell in each subfield using a combination corresponding to the image signal.

The initializing operation includes the following operations:
an all-cell initializing operation of causing initializing discharge in a discharge cell regardless of the operation in the immediately preceding subfield; and
a selective initializing operation of selectively causing initializing discharge only in a discharge cell having undergone address discharge in the address period and having undergone sustain discharge in the sustain period in the immediately preceding subfield.

In the all-cell initializing operation, an increasing up-ramp waveform voltage and a decreasing down-ramp waveform voltage are applied to scan electrodes 22, and initializing discharge is caused in all discharge cells in the image display region. An all-cell initializing operation is performed in the initializing period of one subfield, of a plurality of subfields, and a selective initializing operation is performed in the initializing periods of the other subfields. Hereinafter, the initializing period for performing the all-cell initializing operation is referred to as “all-cell initializing period”, and a subfield having the all-cell initializing period is referred to as “all-cell initializing subfield”. The initializing period for performing the selective initializing operation is referred to as “selective initializing period”, and a subfield having the selective initializing period is referred to as “selective initializing subfield”.

In the present exemplary embodiment, the all-cell initializing subfield is only the first subfield of each field (the subfield firstly occurring in the field). In other words, the all-cell initializing operation is performed in the initializing period of the first sub field (subfield SF1), and the selective initializing operation is performed in the initializing periods of the other subfields. Thus, the initializing discharge can be caused in all discharge cells at least once per field, and the address operations after the all-cell initializing operation can be stabilized. The light emission related to no image display is only light emission following the discharge of the all-cell initializing operation in subfield SF1. The luminance of black level, which is luminance in a black displaying region that does not cause sustain discharge, is therefore determined only by weak light emission in the all-cell initializing operation. An image of sharp contrast can be displayed on panel 10.

In the present exemplary embodiment, however, the number of subfields constituting one field and the luminance weight of each subfield are not limited to the above-mentioned numerical values. The subfield structure may be changed based on an image signal or the like.

In the present exemplary embodiment, an image signal to be input to plasma display apparatus 40 is a 2D image signal or 3D image signal, and plasma display apparatus 40 drives panel 10 in response to each image signal. First, a driving voltage waveform applied to each electrode of panel 10 when a 2D image signal is input to plasma display apparatus 40 is described. Next, a driving voltage waveform applied to each electrode of panel 10 when a 3D image signal is input to plasma display apparatus 40 is described.

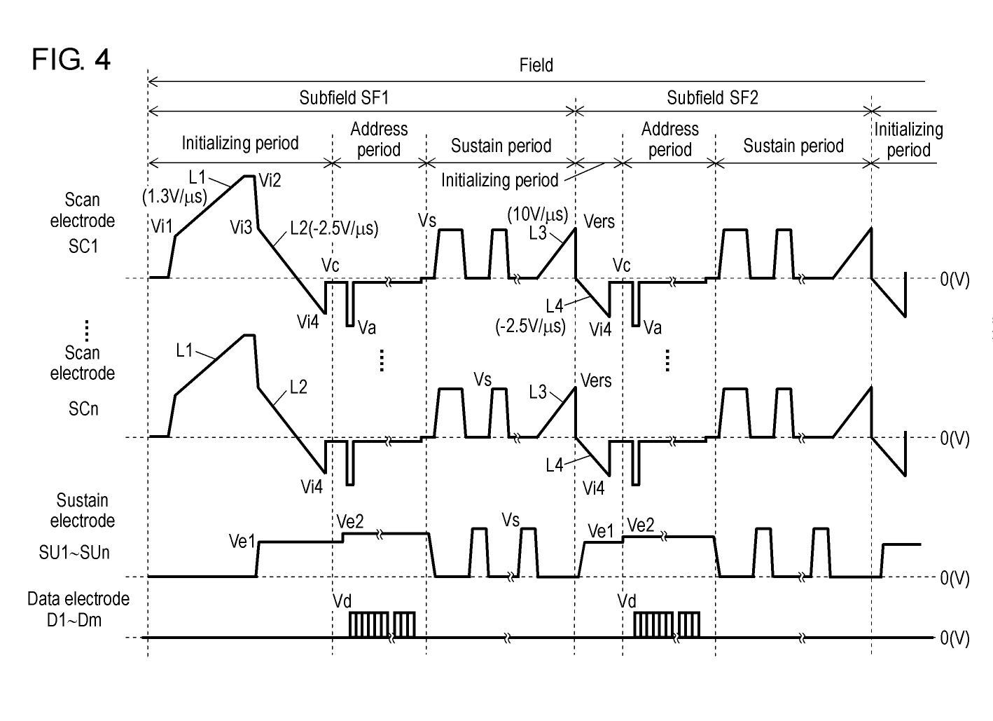

FIG. 4 is a diagram for schematically showing a driving voltage waveform to be applied to each electrode of panel 10 used in the plasma display apparatus in accordance with the first exemplary embodiment of the present invention. FIG. 4 shows driving voltage waveforms applied to scan electrode SC1 for firstly performing an address operation in the address period, scan electrode SCn for finally performing the address operation in the address period, sustain electrode SU1 through sustain electrode SUn, and data electrode D1 through data electrode Dm. Each of scan electrode SCi, sustain electrode SUi, and data electrode Dk discussed later means an electrode that is selected from each kind of electrodes based on image data (which indicates light emission or no light emission in each subfield).

FIG. 4 shows driving voltage waveforms of two subfields, namely subfield SF1 and subfield SF2. The all-cell initializing operation is performed in subfield SF1, and the selective initializing operation is performed in subfield SF2. Therefore, the waveform of the driving voltage to be applied to scan electrode 22 in the initializing period differs between subfield SF1 and subfield SF2. The driving voltage waveforms in the other subfields are the same as the driving voltage waveform in subfield SF2 except for the number of sustain pulses in the sustain period.

In the present exemplary embodiment, when plasma display apparatus 40 drives panel 10 with a 2D image signal, one field is formed of eight subfields (subfield SF1, subfield SF2, subfield SF3, subfield SF4, subfield SF5, subfield SF6, subfield SF7, subfield SF8), and respective subfields, namely subfield SF1 through subfield SF8, have luminance weights of (1, 2, 4, 8, 16, 32, 64, 128).

Thus, when panel 10 is driven in response to a 2D image signal in the present exemplary embodiment, the luminance weights of respective subfields are set in the following manner: the luminance weight of subfield SF1, which is the first subfield in the field, is the smallest, the luminance weights of the subsequent subfields increase sequentially, and the luminance weight of subfield SF8, which is the final subfield in the field, is the largest.

In the present exemplary embodiment, the number of subfields constituting one field and the luminance weight of each subfield are not limited to the above-mentioned values.

First, subfield SF1, which is an all-cell initializing subfield, is described.

In the first half of the initializing period of subfield SF1 for performing an all-cell initializing operation, voltage 0 (V) is applied to data electrode D1 through data electrode Dm and sustain electrode SU1 through sustain electrode SUn. To scan electrode SC1 through scan electrode SCn, voltage 0 (V) is applied, then Vi1 is applied, and then up-ramp waveform voltage, which gently (at a gradient of 1.3 V/μsec, for example) increases from voltage Vi1 to voltage Vi2, is applied. Hereinafter, the up-ramp waveform voltage is referred to as “ramp voltage L1”. Voltage Vi1 is set at a voltage lower than the discharge start voltage with respect to sustain electrode SU1 through sustain electrode SUn. Voltage Vi2 is set at a voltage exceeding the discharge start voltage.

While ramp voltage L1 increases, feeble initializing discharge continuously occurs between scan electrode SC1 through scan electrode SCn and sustain electrode SU1 through sustain electrode SUn in each discharge cell, and feeble initializing discharge continuously occurs between scan electrode SC1 through scan electrode SCn and data electrode D1 through data electrode Dm in each discharge cell. Then, negative wall voltage is accumulated on scan electrode SC1 through scan electrode SCn, and positive wall voltage is accumulated on data electrode D1 through data electrode Dm and sustain electrode SU1 through sustain electrode SUn.

The wall voltage on the electrode means voltage generated by the wall charge accumulated on the dielectric layer for covering the electrodes, the protective layer, or the phosphor layers.

In the latter half of the initializing period of subfield SF1, positive voltage Ve1 is applied to sustain electrode SU1 through sustain electrode SUn, and voltage 0 (V) is applied to data electrode D1 through data electrode Dm. Down-ramp waveform voltage, which gently (at a gradient of −2.5 V/μsec, for example) decreases from voltage Vi3 to negative voltage Vi4, is applied to scan electrode SC1 through scan electrode SCn. Hereinafter, the down-ramp waveform voltage is referred to as “ramp voltage L2”. Voltage Vi3 is set at a voltage lower than the discharge start voltage with respect to sustain electrode SU1 through sustain electrode SUn, and voltage Vi4 is set at a voltage exceeding the discharge start voltage.

While ramp voltage L2 is applied to scan electrode SC1 through scan electrode SCn, feeble initializing discharge occurs between scan electrode SC1 through scan electrode SCn and sustain electrode SU1 through sustain electrode SUn in each discharge cell, and feeble initializing discharge occurs between scan electrode SC1 through scan electrode SCn and data electrode D1 through data electrode Dm in each discharge cell. Then, the negative wall voltage accumulated on scan electrode SC1 through scan electrode SCn and the positive wall voltage accumulated on sustain electrode SU1 through sustain electrode SUn are reduced, and the positive wall voltage accumulated on data electrode D1 through data electrode Dm is adjusted to a value suitable for address operation.

Thus, the initializing operation in the initializing period of subfield SF1, namely the all-cell initializing operation of causing initializing discharge in all discharge cells, is completed, and the wall charge required for the subsequent address operation is produced on each electrode in all discharge cells.

In the subsequent address period in subfield SF1, voltage Ve2 is applied to sustain electrode SU1 through sustain electrode SUn, and voltage Vc (Va+Vscn) is applied to scan electrode SC1 through scan electrode SCn.

Next, a scan pulse of negative polarity of negative voltage Va is applied to scan electrode SC1 in the first row for firstly performing an address operation. Then, an address pulse of positive polarity of positive voltage Vd is applied to data electrode Dk in the discharge cell to emit light in the first row, of data electrode D1 through data electrode Dm.

The voltage difference in the intersecting part of data electrode Dk and scan electrode SC1 in the discharge cell to which the address pulse of voltage Vd has been applied is derived by adding the difference between the wall voltage on data electrode Dk and that on scan electrode SC1 to the difference (voltage Vd−voltage Va) of the external applied voltage. Thus, the voltage difference between data electrode Dk and scan electrode SC1 exceeds the discharge start voltage, and discharge occurs between data electrode Dk and scan electrode SC1.

Since voltage Ve2 is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (voltage Ve2−voltage Va) of the external applied voltage. At this time, by setting voltage Ve2 at a voltage value slightly lower than the discharge start voltage, a state where discharge does not occur but is apt to occur can be caused between sustain electrode SU1 and scan electrode SC1.

Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell (to emit light) to which a scan pulse and address pulse are simultaneously applied, positive wall voltage is accumulated on scan electrode SC1, negative wall voltage is accumulated on sustain electrode SU1, and negative wall voltage is also accumulated on data electrode Dk.

Thus, the address operation in the discharge cell in the first row is completed. The voltage in the part where scan electrode SC1 intersects with data electrode 32 to which no address pulse has been applied does not exceed the discharge start voltage, so that address discharge does not occur.

Next, a scan pulse is applied to scan electrode SC2 in the second row, an address pulse is applied to data electrode Dk corresponding to the discharge cell to emit light in the second row, and the address operation is performed in the discharge cell of the second row.

This address operation is sequentially performed until it reaches the discharge cell in the n-th row in the order of scan electrode SC3, scan electrode SC4, . . . , and scan electrode SCn, and the address period in subfield SF1 is completed. Thus, in the address period, address discharge is selectively caused in the discharge cell to emit light, and wall charge is formed in the discharge cell.

In the subsequent sustain period in subfield SF1, voltage 0 (V) as base potential is firstly applied to sustain electrode SU1 through sustain electrode SUn, and a sustain pulse of positive voltage Vs is applied to scan electrode SC1 through scan electrode SCn.

In the discharge cell having undergone address discharge, by the application of the sustain pulse, the voltage difference between scan electrode SCi and sustain electrode SUi is obtained by adding the difference between the wall voltage on scan electrode SCi and that on sustain electrode SUi to voltage Vs of the sustain pulse.

Thus, the voltage difference between scan electrode SCi and sustain electrode SUi exceeds the discharge start voltage, and sustain discharge occurs between scan electrode SCi and sustain electrode SUi. Ultraviolet rays generated by this discharge cause phosphor layer 35 to emit light. By this discharge, negative wall voltage is accumulated on scan electrode SCi, and positive wall voltage is accumulated on sustain electrode SUi. Positive wall voltage is also accumulated on data electrode Dk. In the discharge cell having undergone no address discharge in the address period, sustain discharge does not occur.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge immediately before it, the voltage difference between sustain electrode SUi and scan electrode SCi exceeds the discharge start voltage. Thus, sustain discharge occurs between sustain electrode SUi and scan electrode SCi again, negative wall voltage is accumulated on sustain electrode SUi, and positive wall voltage is accumulated on scan electrode SCi.

Hereinafter, similarly, as many sustain pulses as the number derived by multiplying the luminance weight by a predetermined luminance magnification are alternately applied to scan electrode SC1 through scan electrode SCn and sustain electrode SU1 through sustain electrode SUn. Thus, by applying the potential difference between the electrodes of display electrode pair 24, sustain discharge is continuously performed in the discharge cell having undergone the address discharge in the address period.

After generation of a sustain pulse in the sustain period (at the end of the sustain period), in the state where voltage 0 (V) is applied to sustain electrode SU1 through sustain electrode SUn and data electrode D1 through data electrode Dm, ramp waveform voltage, which gently (at a gradient of about 10 V/μsec, for example) increases from voltage 0 (V) as base potential to voltage Vers, is applied to scan electrode SC1 through scan electrode SCn. Hereinafter, the ramp waveform voltage is referred to as “erasing ramp voltage L3”.

While erasing ramp voltage L3 applied to scan electrode SC1 through scan electrode SCn increases beyond the discharge start voltage, feeble discharge continuously occurs in the discharge cell having undergone sustain discharge. Charged particles generated by the feeble discharge are accumulated as wall charge on sustain electrode SUi and scan electrode SCi so as to reduce the voltage difference between sustain electrode SUi and scan electrode SCi. Therefore, the wall voltages on scan electrode SCi and sustain electrode SUi are reduced while the positive wall voltage is left on data electrode Dk. In other words, unnecessary wall charge in the discharge cell is erased.

When the voltage applied to scan electrode SC1 through scan electrode SCn arrives at voltage Vers, the apply voltage to scan electrode SC1 through scan electrode SCn is decreased to voltage 0 (V). Thus, the sustain operation in the sustain period in subfield SF1 is completed.

Thus, subfield SF1 is completed.

In the initializing period of subfield SF2 for performing the selective initializing operation, a selective initializing operation is performed where the driving voltage waveform in which the first half of the initializing period of subfield SF1 is omitted is applied to each electrode.

In the initializing period of subfield SF2, voltage Ve1 is applied to sustain electrode SU1 through sustain electrode SUn, and voltage 0 (V) is applied to data electrode D1 through data electrode Dm. Ramp waveform voltage, which decreases from voltage (e.g. voltage 0 (V)) lower than the discharge start voltage to negative voltage Vi4 at the same gradient (e.g. about −2.5 V/μsec) as that of ramp voltage L2, is applied to scan electrode SC1 through scan electrode SCn. Hereinafter, the ramp waveform voltage is referred to as “ramp voltage L4”. Voltage Vi4 is set to exceed the discharge start voltage with respect to sustain electrode SU1 through sustain electrode SUn.

While ramp voltage L4 is applied to scan electrode SC1 through scan electrode SCn, feeble initializing discharge occurs in the discharge cell having undergone the sustain discharge in the sustain period of the immediately preceding subfield (subfield SF1 in FIG. 4). Then, the wall voltages on scan electrode SCi and sustain electrode SUi are reduced by the initializing discharge. Since sufficient positive wall voltage is accumulated on data electrode Dk by sustain discharge occurring in the sustain period of the immediately preceding subfield, the excessive part of this wall voltage is discharged, and the wall voltage on data electrode Dk is adjusted to the wall voltage suitable for the address operation.

In the discharge cell having undergone no sustain discharge in the sustain period of the immediately preceding subfield (subfield SF1), initializing discharge does not occur, and the wall voltage is kept as it is.

The initializing operation in subfield SF2 thus becomes the selective initializing operation of selectively causing initializing discharge in the discharge cell that has undergone address operation in the address period of the immediately preceding subfield, namely in the discharge cell that has undergone sustain discharge in the sustain period of the immediately preceding subfield.

Thus, the initializing operation in the initializing period in subfield SF2, namely the selective initializing operation, is completed.

In the address period of subfield SF2, the address operation is performed where a driving voltage waveform similar to that in the address period of subfield SF1 is applied to each electrode, and wall voltage is accumulated on each electrode of the discharge cell to emit light.

In the subsequent sustain period, similarly to the sustain period of subfield SF1, as many sustain pulses as the number corresponding to the luminance weight are alternately applied to scan electrode SC1 through scan electrode SCn and sustain electrode SU1 through sustain electrode SUn, and sustain discharge is caused in the discharge cell that has undergone address discharge in the address period.

In the initializing period and address period of each of subfield SF3 and later, a driving voltage waveform similar to that in the initializing period and address period of subfield SF2 is applied to each electrode. In the sustain period of each of subfield SF3 and later, a driving voltage waveform similar to that in subfield SF2 is applied to each electrode except for the number of sustain pulses generated in the sustain period.

The driving voltage waveform applied to each electrode of panel 10 of the present exemplary embodiment has been described schematically.

In the present exemplary embodiment, the following voltage values are applied to respective electrodes, for example. Voltage Vi1 is 145 (V), voltage Vi2 is 335 (V), voltage Vi3 is 190 (V), voltage Vi4 is −160 (V), voltage Va is −180 (V), voltage Vs is 190 (V), voltage Vers is 190 (V), voltage Ve1 is 125 (V), voltage Ve2 is 130 (V), and voltage Vd is 60 (V). Voltage Vc can be generated by adding positive voltage Vscn=145 (V) to negative voltage Va=180 (V) (Vc=Va+Vscn), and in this case voltage Vc is −35 (V).

The specific numerical values of the voltage values and gradients of the ramp waveform voltage are simply one example, and the voltage values and gradients of the present invention are not limited to the above-mentioned numerical values. Preferably, the voltage values and gradients are set at optimal values based on the discharge characteristics of the panel and the specification of the plasma display apparatus.

Next, a driving voltage waveform that is applied to each electrode of panel 10 when a 3D image signal is input to plasma display apparatus 40 is described using an opening/closing operation of the shutters of shutter glasses 50.

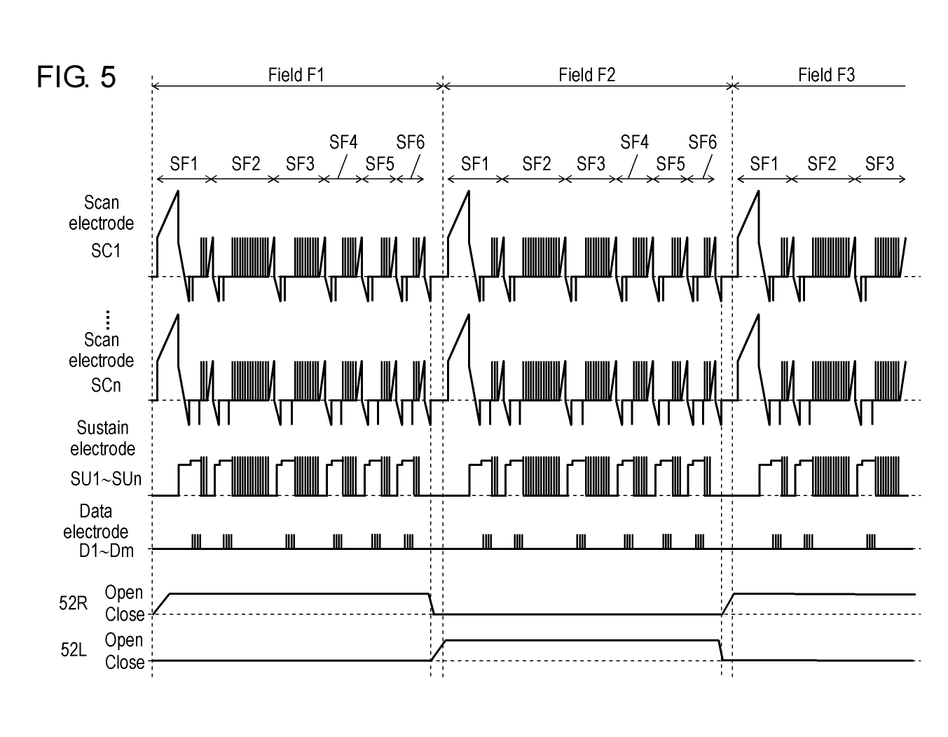

FIG. 5 is a waveform chart for schematically showing a driving voltage waveform applied to each electrode of panel 10 used in plasma display apparatus 40 and a shutter opening/closing operation of shutter glasses 50 in accordance with the first exemplary embodiment of the present invention.

FIG. 5 shows driving voltage waveforms applied to scan electrode SC1 for firstly performing an address operation in the address period, scan electrode SCn for finally performing the address operation in the address period, sustain electrode SU1 through sustain electrode SUn, and data electrode D1 through data electrode Dm. FIG. 5 shows the opening/closing operations of right-eye shutter 52R and left-eye shutter 52L.

The 3D image signal is an image signal for 3D vision for alternately repeating a right-eye image signal and a left-eye image signal in each field. When the 3D image signal is input, plasma display apparatus 40 alternately displays a right-eye image and a left-eye image on panel 10 by alternately repeating a right-eye field for displaying a right-eye image signal and a left-eye field for displaying a left-eye image signal. For example, of three fields (field F1 through field F3) of FIG. 5, field F1 and field F3 are right-eye fields, and display a right-eye image signal on panel 10. Field F2 is a left-eye field, and displays a left-eye image signal on panel 10. Plasma display apparatus 40 displays a 3D image for 3D vision that is formed of the right-eye image and the left-eye image on panel 10.

A user who views a 3D image displayed on panel 10 through shutter glasses 50 recognizes images (right-eye image and left-eye image) displayed in two fields as one 3D image. Therefore, the user observes, as a half the field frequency (video frequency), the number of 3D images displayed on panel 10 per unit time (for example, one second).

For example, when the field frequency of the 3D image signal displayed on the panel is 60 Hz, the number of right-eye images displayed on panel 10 per second is 30 and the number of left-eye images displayed on it per second is 30. The user therefore observes 30 3D images per second. Therefore, in order to display 60 3D images per second, the field frequency must be set at 120 Hz, namely two times 60 Hz.

Thus, the field frequency of the 3D image signal is set to be twice (for example, 120 Hz) the normal frequency in order that the user can smoothly observe a 3D moving image, and hence fluctuation (flicker) in image apt to occur when an image of a low field frequency is displayed is reduced.

The user views a 3D image displayed on panel 10 through shutter glasses 50 for independently opening or closing right-eye shutter 52R and left-eye shutter 52L synchronously with the right-eye field and the left-eye field. Thus, the user can observe the right-eye image only with the right eye and observe the left-eye image only with the left eye, so that the 3D image displayed on panel 10 can be viewed three-dimensionally.

The right-eye field and the left-eye field are different from each other only in the image signal to be displayed. The fields have the same structure, for example the same number of subfields constituting one field, the same luminance weight of each subfield, and the same arrangement of the subfields. When no differentiation between the right-eye and left-eye is required, the right-eye field and the left-eye field are simply referred to as fields. The right-eye image signal and the left-eye image signal are simply referred to as image signals. The right-eye image signal and the left-eye image signal are simply referred to as image signals. The structure of the field may be also referred to as a subfield structure.

In plasma display apparatus 40 of the present exemplary embodiment, in order to reduce the flicker (display image fluctuates) when panel 10 is driven in response to a 3D image signal, the field frequency is set to be twice (e.g. 120 Hz) that when the 2D image signal is displayed on panel 10, as discussed above. Therefore, the one-field period (e.g. 8.3 msec) when a 3D image signal is displayed on panel 10 is a half the one-field period (e.g. 16.7 msec) when a 2D image signal is displayed on panel 10.

In plasma display apparatus 40 of the present exemplary embodiment, the number of subfields constituting one field is made smaller when panel 10 is driven in response to a 3D image signal than when panel 10 is driven in response to a 2D image signal. In the present exemplary embodiment, an example is described where each of a right-eye field and a left-eye field has six subfields (subfield SF1, subfield SF2, subfield SF3, subfield SF4, subfield SF5, subfield SF6). Each subfield has an initializing period, an address period, and a sustain period similarly to the case where panel 10 is driven in response to the 2D image signal. An all-cell initializing operation is performed in the initializing period of subfield SF1, and a selective initializing operation is performed in the initializing periods of the other subfields.

Respective subfields, namely subfield SF1 through subfield SF6, have luminance weights of (1, 16, 8, 4, 2, 1). In the present exemplary embodiment, the luminance weights of respective subfields are thus set in the following manner: the luminance weight of subfield SF1, which is the first subfield in the field, is the smallest, the luminance weight of subfield SF2, which is the second subfield, is the largest, and the luminance weights of the subsequent subfields decrease sequentially.

The purpose of the setting is as follows:
a subfield of a relatively large luminance weight is generated at the beginning of the field, the leak of afterglow to the next field is reduced as much as possible, and the crosstalk when a 3D image signal is displayed on panel 10 is suppressed; and
the number of discharge cells to which wall charge and priming particles are supplied is increased by the sustain discharge caused in the sustain period of subfield SF1, and the address operation in the subsequent subfield is stabilized.
   This crosstalk means leak of emitted light from a right-eye image to a left-eye image, and leak of emitted light from a left-eye image to a right-eye image.

In the present exemplary embodiment, the number of subfields constituting one field and the luminance weight of each subfield are not limited to the above-mentioned values.

The driving voltage waveform applied to each electrode in each subfield is similar to that when a 2D image signal is displayed on panel 10 except for the number of sustain pulses occurring in the sustain period, and hence is not described.

The opening/closing operation of right-eye shutter 52R and left-eye shutter 52L of shutter glasses 50 is controlled based on the ON and OFF of the shutter opening/closing timing signal (right-eye shutter opening/closing timing signal and left-eye shutter opening/closing timing signal) that is output from timing signal output section 46 and is received by shutter glasses 50.

When the driver circuit of plasma display apparatus 40 performs 3D drive, control signal generation circuit 45 performs following operations:
generating a shutter opening/closing timing signal so that right-eye shutter 52R is opened and left-eye shutter 52L is closed in the period in which a right-eye field is displayed on panel 10; and
generating a shutter opening/closing timing signal so that left-eye shutter 52L is opened and right-eye shutter 52R is closed in the period in which a left-eye field is displayed on panel 10.

Next, illumination flicker is described which occurs when there is a time lag between the shutter opening/closing operation of shutter glasses 50 and the blinking cycle of the illumination light (they are not synchronized with each other).

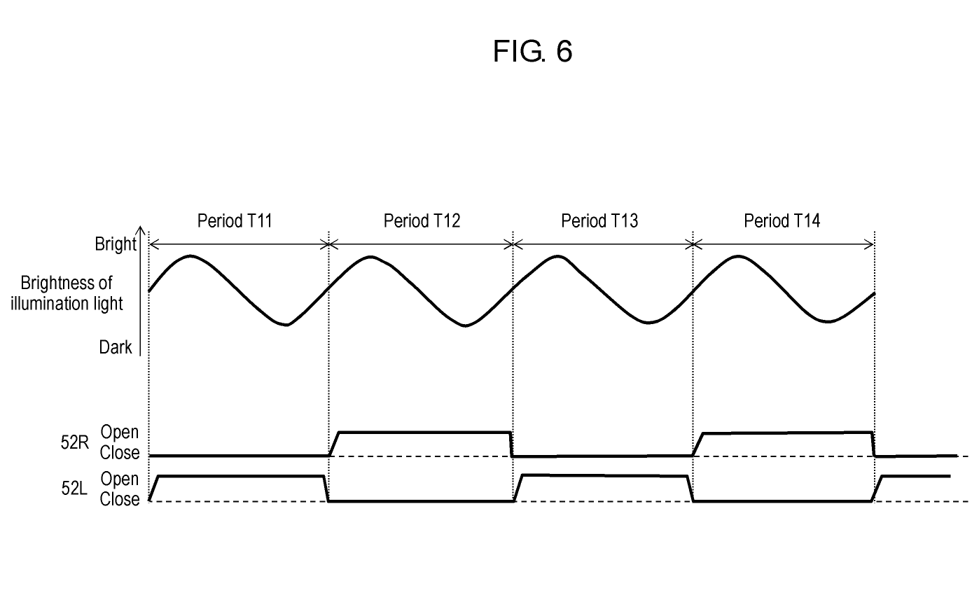

FIG. 6 is a waveform chart for schematically showing an example of the blinking of illumination light in a luminaire for illuminating the environment in which plasma display apparatus 40 is installed and the shutter opening/closing operation of shutter glasses 50.

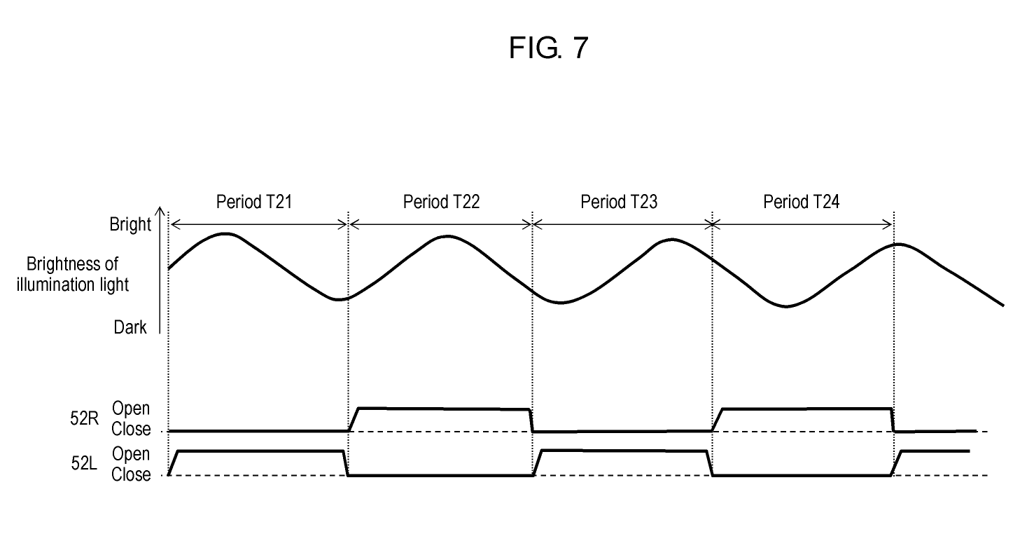

FIG. 7 is a waveform chart for schematically showing another example of the blinking of illumination light in the luminaire for illuminating the environment in which plasma display apparatus 40 is installed and the shutter opening/closing operation of shutter glasses 50.

FIG. 6 and FIG. 7 show waveforms for schematically showing the variation in brightness of the illumination light generated by the luminaire and the opening/closing operations of right-eye shutter 52R and left-eye shutter 52L. In FIG. 6 and FIG. 7, the horizontal axis shows time (the horizontal axis is not shown).

FIG. 6 shows the case where the frequency of AC power supplied to the luminaire for illuminating plasma display apparatus 40 is 60 Hz and the luminaire repeats blinking at a frequency twice that of the AC power supply. Therefore, the illumination frequency of the luminaire becomes 120 Hz, and the luminaire repeats a high illuminance state (bright) and a low illuminance state (dark) 120 times per second.

At this case, for example, when a 3D image of a field frequency (video frequency) of 120 Hz is displayed on plasma display apparatus 40, each of right-eye shutter 52R and left-eye shutter 52L of shutter glasses 50 repeats 60 opening/closing operations per second.

In this condition, the blinking cycle (illumination frequency) of illumination light is made substantially coincide with the shutter opening/closing operation of shutter glasses 50 (they are synchronized with each other). Therefore, the variation in brightness of the illumination light is substantially the same between respective periods in which the shutters are opened as shown in FIG. 6. For example, as shown in FIG. 6, the variations in brightness of the illumination light in period T11, period T12, period T13, and period T14 are substantially the same.

A user who views a 3D image displayed on panel 10 through shutter glasses 50 also receives illumination light through shutter glasses 50 with the eyes of the user.

In this condition, therefore, the variation in brightness of the illumination light entering the eyes of the user through shutter glasses 50 is substantially the same between respective periods when the shutters of shutter glasses 50 are opened. Therefore, it is considered that the user does not sense temporal variation in brightness of the illumination light and the user does not especially feel discomfort about the illumination light.

FIG. 7 shows the case where the frequency of AC power supplied to the luminaire for illuminating plasma display apparatus 40 is 50 Hz and the luminaire repeats blinking at a frequency twice that of the AC power supply. Therefore, the illumination frequency of the luminaire becomes 100 Hz, and the luminaire repeats a high illuminance state (bright) and a low illuminance state (dark) 100 times per second.

At this case, similarly, when a 3D image of a field frequency (video frequency) of 120 Hz is displayed on plasma display apparatus 40, each of right-eye shutter 52R and left-eye shutter 52L of shutter glasses 50 repeats 60 opening/closing operations per second.

In this condition, a time lag occurs between the blinking cycle (illumination frequency) of illumination light and the shutter opening/closing operation of shutter glasses 50. Therefore, the variation in brightness of the illumination light is different between respective periods when the shutters are opened as shown in FIG. 7.

For example, as shown in FIG. 7, when period T21 and period T23 in which left-eye shutter 52L is opened are compared with each other, the brightness of the illumination light arriving at the left eye of the user through left-eye shutter 52L is slightly higher in period T21 than in period T23. When period T22 and period T24 in which right-eye shutter 52R is opened are compared with each other, the brightness of the illumination light arriving at the right eye of the user through right-eye shutter 52R is higher in period T22 than in period T24.

When the brightness of the illumination light arriving at the eyes of the user varies with time in an opened state of the shutters, the user feels as if the brightness of the illumination light varies with time. Thus, illumination flicker occurs.

Thus, when the illumination frequency is equal to the field frequency of the 3D image signal (for example, when both the illumination frequency and the field frequency of the 3D image signal are 120 Hz, or when both the illumination frequency and the field frequency of the 3D image signal are 100 Hz), the user who views the 3D image displayed on panel 10 through shutter glasses 50 does not especially feel discomfort about the illumination light. When the illumination frequency is different from the field frequency of the 3D image signal (for example, when the illumination frequency is 100 Hz and the field frequency of the 3D image signal is 120 Hz, or when the illumination frequency is 120 Hz and the field frequency of the 3D image signal is 100 Hz), the user feels fluctuation of the illumination light and it is considered that illumination flicker occurs.

In the plasma display system of the present exemplary embodiment, in order to prevent the occurrence of the illumination flicker, the field frequency of the 3D image signal is altered in response to the illumination frequency. For example, when the illumination frequency is 100 Hz and the field frequency of the 3D image signal is 120 Hz, the field frequency of the 3D image signal is altered to 100 Hz. When the illumination frequency is 120 Hz and the field frequency of the 3D image signal is 100 Hz, the field frequency of the 3D image signal is altered to 120 Hz.

Thus, in the present exemplary embodiment, when the illumination frequency is different from the field frequency of the 3D image signal, the field frequency of the 3D image signal is altered so that the field frequency of the 3D image signal becomes equal to the illumination frequency. The timing of the opening/closing operations of right-eye shutter 52R and left-eye shutter 52L is made to coincide with the blinking cycle of the illumination to provide the state where they are synchronized with each other, and the user who views the 3D image through shutter glasses 50 is prevented from sensing illumination flicker.

Next, the details of illuminance detecting circuit 47, illumination light frequency detecting circuit 48, and video frequency converting circuit 49 are described.

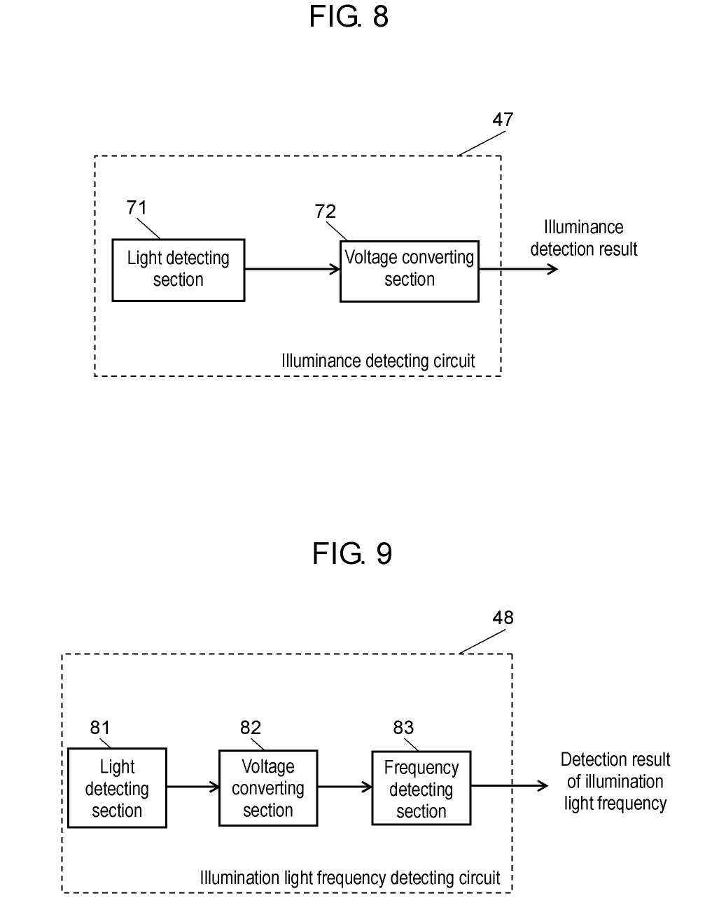

FIG. 8 is a diagram for schematically showing the circuit block of illuminance detecting circuit 47 in accordance with the first exemplary embodiment of the present invention.

Illuminance detecting circuit 47 has light detecting section 71 and voltage converting section 72.

Light detecting section 71 is formed of an element where the resistance value or generation current varies in response to the light intensity (illuminance), and detects the brightness (illuminance) of the periphery of plasma display apparatus 40. As such an element, a photo-resistor, a photo-diode, a photo-transistor, or a solar cell is used.

Voltage converting section 72 converts the detection result of light detecting section 71 into voltage. This voltage, as a signal indicating the illuminance detection result of illuminance detecting circuit 47, is supplied to subsequent video frequency converting circuit 49.

FIG. 9 is a diagram for schematically showing the circuit block of illumination light frequency detecting circuit 48 in accordance with the first exemplary embodiment of the present invention.

Illumination light frequency detecting circuit 48 has light detecting section 81, voltage converting section 82, and frequency detecting section 83.

Light detecting section 81 has a configuration and operation similar to those of light detecting section 71, and detects the illuminance of the periphery of plasma display apparatus 40. Light detecting section 81 detects the blinking of the illumination light generated by a luminaire, and has a response speed high enough to detect the blinking of the illumination light when the blinking is about 240 Hz or smaller, for example.

Voltage converting section 82 converts the detection result of light detecting section 81 into voltage.

Frequency detecting section 83 detects temporal variation in voltage output from voltage converting section 82, converts the detection result into a signal indicating the frequency, and outputs the signal. This signal, as the detection result of illumination light frequency detecting circuit 48 (namely illumination frequency), is supplied to subsequent video frequency converting circuit 49.

Light detecting section 81 and voltage converting section 82 may have configurations replaced by those of light detecting section 71 and voltage converting section 72

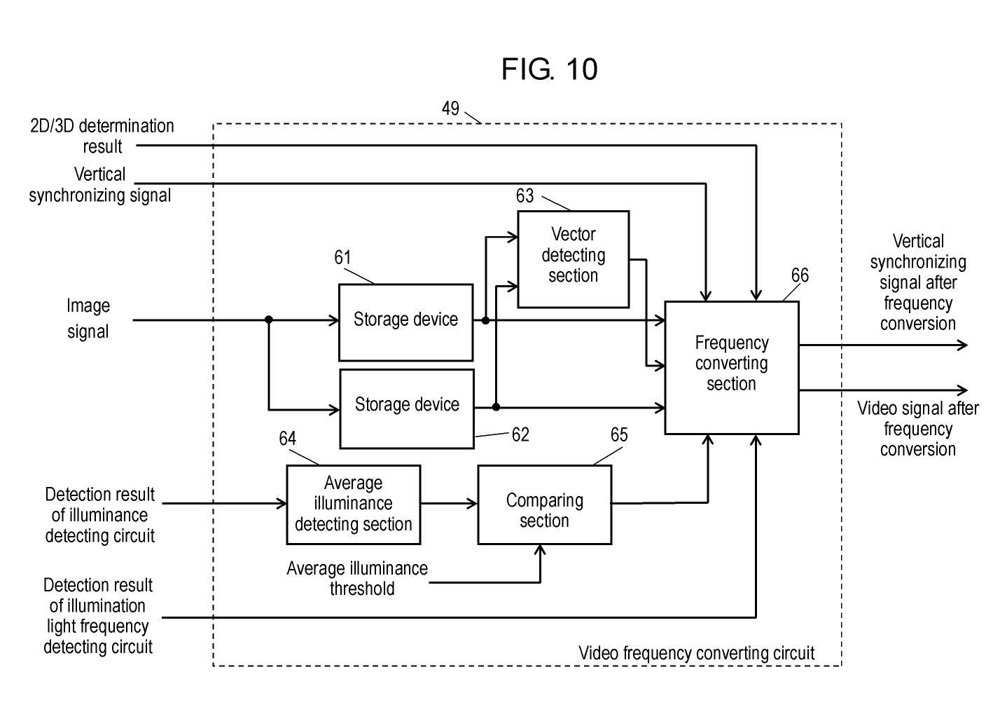

FIG. 10 is a diagram for schematically showing the circuit block of video frequency converting circuit 49 in accordance with the first exemplary embodiment of the present invention.

Video frequency converting circuit 49 has storage device 61, storage device 62, vector detecting section 63, average illuminance detecting section 64, comparing section 65, and frequency converting section 66.

Storage device 61 is formed of a generally used semiconductor storage device (dynamic random access memory (DRAM) or the like) capable of optionally performing reading and writing, for example, and outputs an image signal input to video frequency converting circuit 49 while the image signal is delayed temporally. This delay is performed for time regulation in the subsequent circuit block when the field frequency of a 3D image signal is altered.

Storage device 62 is formed of a generally used semiconductor storage device (DRAM or the like) capable of optionally performing reading and writing, for example, and outputs an image signal input to video frequency converting circuit 49 while the image signal is delayed temporally. This delay time is equal to the time derived by adding the time of two-field period to the delay time of storage device 61. Therefore, storage device 62 outputs an image signal that is temporally delayed by the two-field period from the image signal output from storage device 61. Thus, when storage device 61 outputs an image signal of the right-eye field, storage device 62 outputs an image signal of the right-eye field immediately before the former right-eye field. When storage device 61 outputs an image signal of the left-eye field, storage device 62 outputs an image signal of the left-eye field immediately before the former left-eye field.

Vector detecting section 63 performs vector detection of a motion image region using an image signal output from storage device 61 and an image signal output from storage device 62. This vector detection is performed by pattern matching generally known as one of image signal processing methods. In other words, by comparing the image signal output from storage device 61 with the image signal output from storage device 62, two temporally continuous images are compared with each other, the motion image region is detected, and vector detecting section 63 detects which motion image region moves in which direction and for how long distance. The two temporally continuous images mean two temporally continuous right-eye images and two temporally continuous left-eye images, and do not mean two temporally continuous fields.

Average illuminance detecting section 64 calculates the average value of the illuminance in a predetermined period as the average illuminance using the detection result of illuminance detecting circuit 47. This predetermined period is 10 sec, for example. In the present exemplary embodiment, however, the time length when the average illuminance is calculated is not limited to 10 sec, but may be shorter than 10 sec or 10 sec or longer. Preferably, the time when the average illuminance is calculated is set optimally in response to the specification or the like of plasma display apparatus 40.

Comparing section 65 compares the average illuminance detected by average illuminance detecting section 64 with a preset average illuminance threshold, determines whether the average illuminance is lower than the average illuminance threshold, and outputs the determination result. In the present exemplary embodiment, the average illuminance threshold is a numerical value equivalent to 301 lux, for example. However, the numerical value of 301 lux is simply one example, and the average illuminance threshold is not limited to the numerical value in the present exemplary embodiment. Preferably, the average illuminance threshold is set optimally in response to the specification or the like of plasma display apparatus 40.

Frequency converting section 66 alters the field frequency of a 3D image signal based on the following factors:
the vertical synchronizing signal transmitted from control signal generation circuit 45;
the signal (hereinafter referred to as “2D/3D determination result”) indicating a determination result of whether an input image signal is a 2D image signal or 3D image signal;
the detection result of illumination light frequency detecting circuit 48, namely illumination frequency; and
the comparison result of comparing section 65.
   The field frequency is altered by generating an interpolation image from two temporally continuous images using the detection result of vector detecting section 63, the image signal output from storage device 61, and the image signal output from storage device 62. The interpolation image means an image positioned between two temporally continuous images, and means an image generated when the number of images per unit time (e.g. one second) is altered.

Specifically, frequency converting section 66 determines the field frequency based on the vertical synchronizing signal transmitted from control signal generation circuit 45, and determines whether the image signal is a 2D image signal or 3D image signal based on the 2D/3D determination result. When the image signal is a 3D image signal, frequency converting section 66 compares the illumination frequency with the filed frequency of the image signal. When the image signal is a 3D image signal and the illumination frequency is different from the filed frequency of the image signal, frequency converting section 66 alters the filed frequency of the image signal so that the filed frequency becomes equal to the illumination frequency, and also alters the frequency of the vertical synchronizing signal. For example, when the illumination frequency is 100 Hz and the filed frequency of the image signal is 120 Hz, frequency converting section 66 generates a 3D image signal where the filed frequency is altered from 120 Hz to 100 Hz, and also alters the frequency of the vertical synchronizing signal from 120 Hz to 100 Hz. When the illumination frequency is 120 Hz and the filed frequency of the image signal is 100 Hz, frequency converting section 66 generates a 3D image signal where the filed frequency is altered from 100 Hz to 120 Hz, and also alters the frequency of the vertical synchronizing signal from 100 Hz to 120 Hz.

When the image signal is a 2D image signal, or when the illumination frequency is equal to the filed frequency of the 3D image signal, however, frequency converting section 66 does not alter the filed frequency. Even if the illumination frequency is different from the filed frequency of the 3D image signal, frequency converting section 66 does not alter the filed frequency when the average illuminance is lower than the average illuminance threshold in the comparison result of comparing section 65. This is because, even if all conditions for causing illumination flicker are satisfied, the illumination flicker is hardly recognized by a user when the illumination light is sufficiently dark. Therefore, preferably, the average illuminance threshold is set using, as the reference, whether or not a user senses the illumination flicker under the conditions for causing the illumination flicker.

Next, an example when frequency converting section 66 alters a 3D image signal of a field frequency of 120 Hz to a 3D image signal of 100 Hz is described using a drawing.

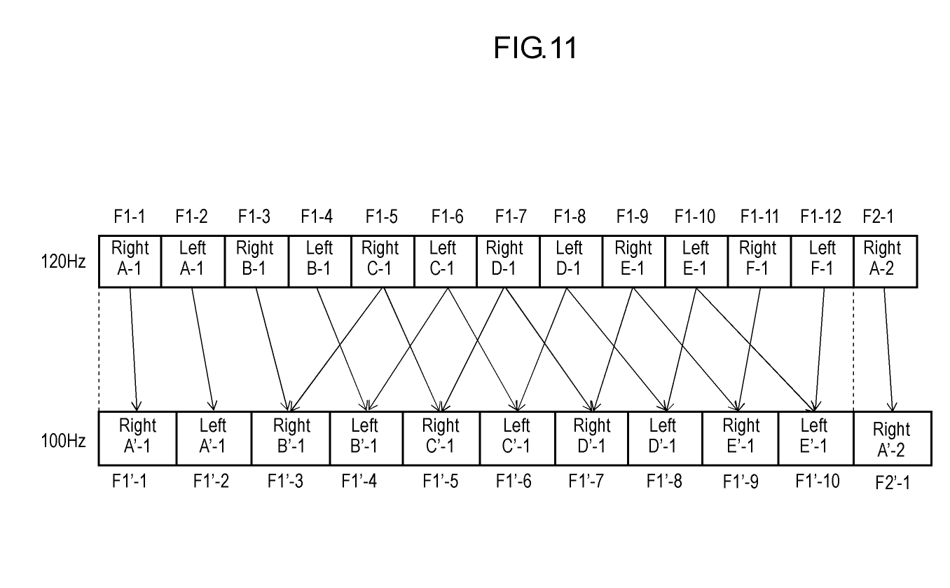

FIG. 11 is a diagram for schematically showing an example when frequency converting section 66 converts a 3D image signal of a field frequency of 120 Hz into a 3D image signal of a field frequency of 100 Hz in accordance with the first exemplary embodiment of the present invention.

When a 3D image signal of a field frequency of 120 Hz is converted into a 3D image signal of a field frequency of 100 Hz, 12 images (12 fields) are converted into 10 images (10 fields). Therefore, FIG. 11 shows an example where 12 images of field F1-1 through field F1-12 are converted into 10 images of field F1′-1 through field F1′-10. In other words, in the example of FIG. 11, six 3D images are converted into five 3D images.

In FIG. 11, field F1-1 is right-eye image A-1 (hereinafter referred to as “right A-1”), field F1-2 is left-eye image A-1 (hereinafter referred to as “left A-1”), field F1-3 is right-eye image B-1 (hereinafter referred to as “right B-1”), field F1-4 is left-eye image B-1 (hereinafter referred to as “left B-1”), field F1-5 is right-eye image C-1 (hereinafter referred to as “right C-1”), field F1-6 is left-eye image C-1 (hereinafter referred to as “left C-1”), field F1-7 is right-eye image D-1 (hereinafter referred to as “right D-1”), field F1-8 is left-eye image D-1 (hereinafter referred to as “left D-1”), field F1-9 is right-eye image E-1 (hereinafter referred to as “right E-1”), field F1-10 is left-eye image E-1 (hereinafter referred to as “left E-1”), field F1-11 is right-eye image F-1 (hereinafter referred to as “right F-1”), and field F1-12 is left-eye image F-1 (hereinafter referred to as “left F-1”).

Frequency converting section 66 of the present exemplary embodiment generates, based on the following equations, five right-eye images of right-eye image A′-1 (right A′-1) through right-eye image E′-1 (right E′-1) after frequency conversion, and five left-eye images of left-eye image A′-1 (left A′-1) through left-eye image E′-1 (left E′-1) after frequency conversion. The following coefficients of k11 through k18 are weighing coefficients for generating the interpolation images.

Right A′-1=right A-1

Right B′-1=k11×right B-1+k12×right C-1

Right C′-1=k13×right C-1+k14×right D-1

Right D′-1=k15×right D-1+k16×right E-1

Right E′-1=k17×right E-1+k18×right F-1

Left A′-1=left A-1

Left B′-1=k11×left B-1+k12×left C-1

Left C′-1=k13×left C-1+k14×left D-1

Left D′-1=k15×left D-1+k16×left E-1

Left E′-1=k17×left E-1+k18×left F-1

Next, weighing coefficients k11 through k18 are described using a drawing.

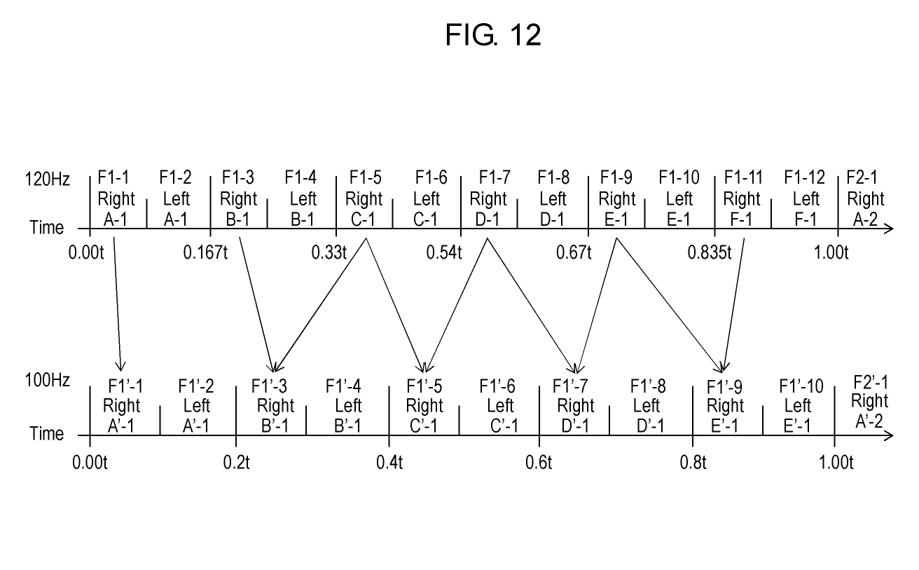

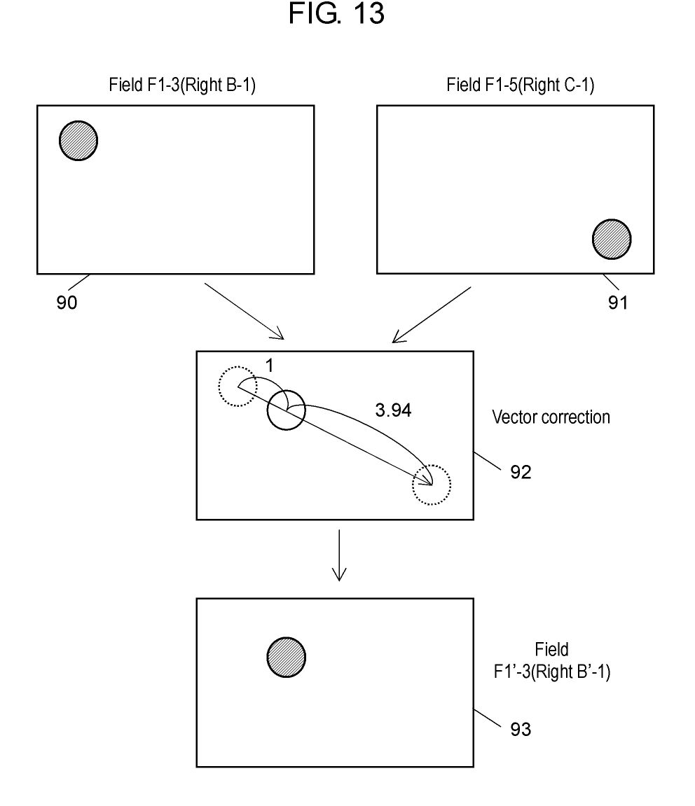

FIG. 12 is a diagram for schematically showing a setting example of the weighing coefficients when frequency converting section 66 converts a 3D image signal of a field frequency of 120 Hz into a 3D image signal of a field frequency of 100 Hz in accordance with the first exemplary embodiment of the present invention.

In the present exemplary embodiment, each of weighing coefficients k11 through k18 is set based on the temporal distances between two continuous images and an interpolation image generated from these images.

For example, as shown in FIG. 12, when the starting time of field F1-1 is set at 0.00 t and the starting time of field F2-1, which is 12 fields later than field F1-1, is set at 1.00 t, the starting time of each right-eye image is as follows.

Right A-1=0.00 t

Right B-1=0.167 t

Right C-1=0.33 t

Right D-1=0.54 t

Right E-1=0.67 t

Right F-1=0.835 t

When the starting time of field F1′-1 after frequency conversion is set at 0.00 t and the starting time of field F2′-1, which is 10 fields later than field F1′-1, is set at 1.00 t, the starting time of each right-eye image after frequency conversion is as follows.

Right A′-1=0.00 t

Right B′-1=0.2 t

Right C′-1=0.4 t

Right D′-1=0.6 t

Right E′-1=0.8 t

Next, a calculating method of the weighing coefficients is described using, as an example, weighing coefficients k11 and k12 used when right B′-1 is generated.

Right B′-1 as a right-eye image after frequency conversion is generated from right B-1 and right C-1 as right-eye images before frequency conversion. As shown in FIG. 12, the starting time of right B′-1 is 0.2 t, the starting time of right B-1 is 0.167 t, and the starting time of right C-1 is 0.33 t. Therefore, the difference between the starting time of right C-1 and that of right B′-1 is (0.33 t−0.2 t), and the difference between the starting time of right B′-1 and that of right B−1 is (0.2 t−0.1670. Therefore, weighing coefficients k11 and k12 used when right B′-1 is generated are set as the following equation.

$$\begin{matrix}k 11 : k 12 = ( 0.33 t - 0.2 t ) : ( 0.2 t - 0.167 t ) \\ = 0.13 t : 0.033 t \\ = 3.94 : 1\end{matrix}$$

When the other weighing coefficients are set similarly to weighing coefficients k11 and k12, the following equations are acquired.

k13:k14=2:1

k15:k16=1.17:1

k17:k18=1:3.7

Each weighing coefficient when a left-eye interpolation image is generated is set similarly to the above-mentioned one.

In the present exemplary embodiment, each weighing coefficient is set in the above-mentioned manner.

Next, a method of generating an interpolation image based on the weighing coefficients is described by taking the example where field F1′-3 (right B′-1) as an interpolation image is generated from field F1-3 (right B-1) and field F1-5 (right C-1).

FIG. 13 is a diagram for schematically showing an example of an operation when frequency converting section 66 generates one right-eye interpolation image from two continuous right-eye images in accordance with the first exemplary embodiment of the present invention.

In FIG. 13, diagram 90 schematically shows an example of field F1-3 (right B-1), and diagram 91 schematically shows an example of field F1-5 (right C-1). FIG. 13 shows the example where a ball displayed at the upper left of the screen in right B-1 moves to the lower right of the screen in right C-1. Diagram 92 schematically shows an example of an operation when an interpolation image is generated from field F1-3 and field F1-5, and diagram 93 schematically shows an example of interpolation image field F1′-3 (right B′-1) that is generated from field F1-3 and field F1-5.

As discussed above, right B′-1 as the interpolation image is expressed by the following equation in the present exemplary embodiment.

Right B′-1=k11×right B-1+k12×right C-1

For example, when weighing coefficients k11 and k12 satisfy k11:k12=3.94:1 as discussed above, the weighing of right B-1 is 3.94 and weighing of right C-1 is 1 when the interpolation image is generated. Therefore, when the ball moves between two continuous images as shown in diagram 90 and diagram 91, the vector indicating the movement of the ball is divided into 1:3.94, and an image is generated where the ball is positioned at a distance of 1 from the ball position in right B-1 and 3.94 from that in right C-1. Thus, interpolation image right B′-1 of diagram 93 is generated.

The other interpolation images are generated in a similar manner based on the above-mentioned equations and weighing coefficients.

Next, an example where frequency converting section 66 converts a 3D image signal of a field frequency of 100 Hz into a 3D image signal of 120 Hz is described using drawings.

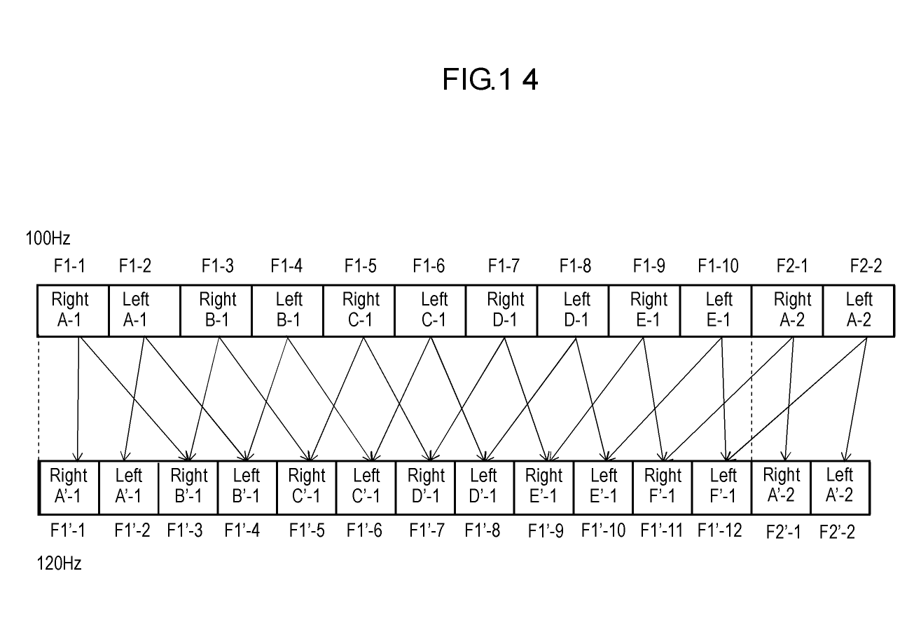

FIG. 14 is a diagram for schematically showing an example when frequency converting section 66 converts a 3D image signal of a field frequency of 100 Hz into a 3D image signal of a field frequency of 120 Hz in accordance with the first exemplary embodiment of the present invention.

When a 3D image signal of a field frequency of 100 Hz is converted into a 3D image signal of a field frequency of 120 Hz, 10 images (10 fields) are converted into 12 images (12 fields). Therefore, FIG. 14 shows an example where 10 images of field F1-1 through field F1-10 are converted into 12 images of field F1′-1 through field F1′-12. In other words, in the example of FIG. 14, five 3D images are converted into six 3D images.

Frequency converting section 66 of the present exemplary embodiment generates, based on the following equations, six right-eye images of right-eye image A′-1 (right A′-1) through right-eye image F′-1 (right F′-1) after frequency conversion, and six left-eye images of left-eye image A′-1 (left A′-1) through left-eye image F′-1 (left F′-1) after frequency conversion. The following coefficients of k21 through k30 are weighing coefficients for generating interpolation images.

Right A′-1=right A-1

Right B′-1=k21×right A-1+k22×right B-1

Right C′-1=k23×right B-1+k24×right C-1

Right D′-1=k25×right C-1+k26×right D-1

Right E′-1=k27×right D-1+k28×right E-1

Right F′-1=k29×right E-1+k30×right A-2

Left A′-1=left A-1

Left B′-1=k21×left A-1+k22×left B-1

Left C′-1=k23×left B-1+k24×left C-1

Left D′-1=k25×left C-1+k26×left D-1

Left E′-1=k27×left D-1+k28×left E-1

Left F′-1=k29×left E-1+k30×left A-2

Next, weighing coefficients k21 through k30 are described using a drawing.

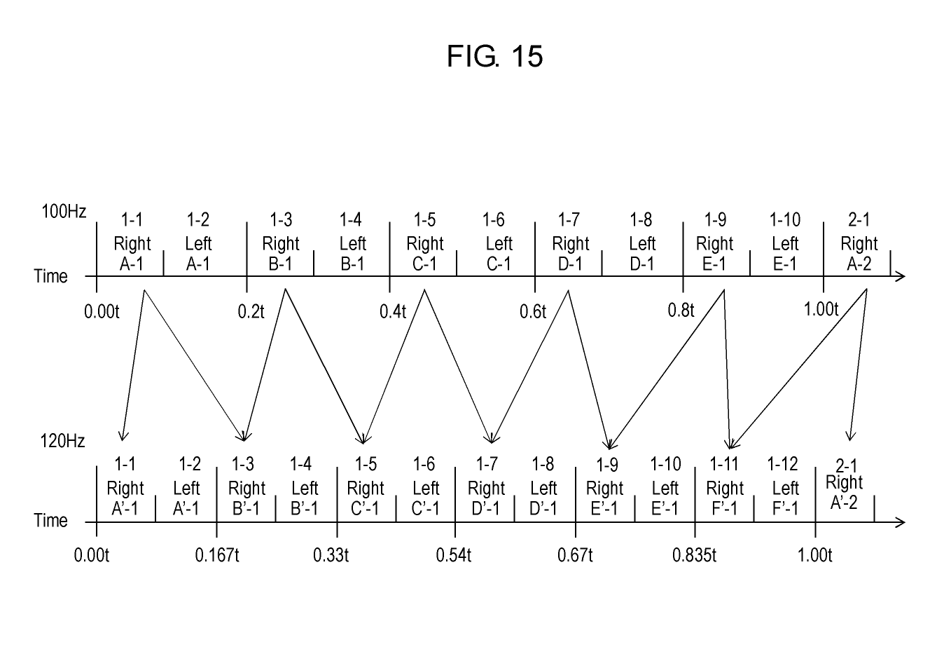

FIG. 15 is a diagram for schematically showing a setting example of the weighing coefficients when frequency converting section 66 converts a 3D image signal of a field frequency of 100 Hz into a 3D image signal of a field frequency of 120 Hz in accordance with the first exemplary embodiment of the present invention.

In the present exemplary embodiment, each of weighing coefficients k21 through k30 is set based on the temporal distances between two continuous images and an interpolation image generated from these images, similarly to each of the weighing coefficients of k11 through k18.

For example, as shown in FIG. 15, when the starting time of field F1-1 is set at 0.00 t and the starting time of field F2-1, which is 10 fields later than field F1-1, is set at 1.00 t, the starting time of each right-eye image is as follows.

Right A-1=0.00 t

Right B-1=0.2 t

Right C-1=0.4 t

Right D-1=0.6 t

Right E-1=0.8 t

When the starting time of field F1′-1 after frequency conversion is set at 0.00 t and the starting time of field F2′-1, which is 12 fields later than field F1′-1, is set at 1.00 t, the starting time of each right-eye image after frequency conversion is as follows.

Right A′-1=0.00 t

Right B′-1=0.167 t

Right C′-1=0.33 t

Right D′-1=0.54 t

Right E′-1=0.67 t

Right F′-1=0.835 t

Next, a calculating method of the weighing coefficients is described using, as an example, weighing coefficients k21 and k22 used when right B′-1 is generated.

Right B′-1 as a right-eye image after frequency conversion is generated from right A-1 and right B-1 as right-eye images before frequency conversion. As shown in FIG. 15, the starting time of right B′-1 is 0.167 t, the starting time of right A-1 is 0.00 t, and the starting time of right B-1 is 0.2 t. Therefore, the difference between the starting time of right B-1 and that of right B′-1 is (0.2 t−0.167 t), and the difference between the starting time of right B′-1 and that of right A-1 is (0.167 t−0.00 t). Therefore, weighing coefficients k21 and k22 used when right B′-1 is generated are set as the following equation.

$$\begin{matrix}K 21 : k 22 = ( 0.2 t - 0.167 t ) : ( 0.167 t - 0.00 t ) \\ = 0.033 t : 0.167 t \\ = 1 : 5.06\end{matrix}$$

When the other weighing coefficients are set similarly to weighing coefficients k21 and k22, the following equations are acquired.

k23:k24=1:1.86

k25:k26=1:2.33

k27:k28=1.86:1

k29:k30=4.71:1

Each weighing coefficient when a left-eye interpolation image is generated is set similarly to the above-mentioned one.

In the present exemplary embodiment, each weighing coefficient is set in the above-mentioned manner.

The operation when the interpolation image is generated based on the weighing coefficients is similar to that of FIG. 13, and hence is not described.

As discussed above, in the present exemplary embodiment, plasma display apparatus 40 detects the illumination frequency by the luminaire for illuminating the environment in which it is installed, and detects the field frequency of a 3D image signal displayed on panel 10. When the illumination frequency is different from the field frequency of the 3D image signal, the field frequency of the 3D image signal is altered so that the field frequency of the 3D image signal is equal to the illumination frequency. When there is a difference between the blinking cycle (illumination frequency) of the illumination light and the field frequency of the 3D image signal, the shutter opening/closing operation of shutter glasses 50 is made to coincide with the blinking cycle of the illumination light (they are synchronized with each other).

For example, when the illumination frequency detected by illumination light frequency detecting circuit 48 is 100 Hz, the field frequency of the 3D image signal displayed on panel 10 is altered from 120 Hz to 100 Hz for example, and the shutter opening/closing timing signal supplied from timing signal output section 46 to shutter glasses 50 is set at 50 Hz (or an integral multiple thereof). Thus, each of right-eye shutter 52R and left-eye shutter 52L repeats 50 opening/closing operations per second, and each opening/closing operation is made to coincide with the blinking cycle of the illumination light (they are synchronized with each other).

Alternatively, when the illumination frequency detected by illumination light frequency detecting circuit 48 is 120 Hz, the field frequency of the 3D image displayed on panel 10 is altered from 100 Hz to 120 Hz for example, and the shutter opening/closing timing signal supplied from timing signal output section 46 to shutter glasses 50 is set at 60 Hz (or an integral multiple thereof). Thus, each of right-eye shutter 52R and left-eye shutter 52L repeats 60 opening/closing operations per second, and each opening/closing operation is made to coincide with the blinking cycle of the illumination light (they are synchronized with each other).

Thus, in the present exemplary embodiment, a user who views a 3D image displayed on panel 10 through shutter glasses 50 can be prevented from sensing illumination flicker. Therefore, a high-quality 3D image can be supplied to a user who views a 3D image displayed on panel 10 through shutter glasses 50.

In the present exemplary embodiment, when the image signal is a 2D image signal, or when the illumination frequency is equal to the filed frequency of the 3D image signal, frequency converting section 66 does not alter the filed frequency. Even if the illumination frequency is different from the filed frequency of the 3D image signal, frequency converting section 66 does not alter the filed frequency when the average illuminance is lower than the average illuminance threshold. Thus, when illumination flicker does not occur or when the illumination flicker is hardly recognized by a user even if illumination flicker occurs, the image based on the input image signal is displayed on panel 10, and the power consumption required for conversion of the filed frequency can be reduced.

In the description of the present exemplary embodiment, when the illumination frequency is different from the field frequency of the 3D image signal, the field frequency of the 3D image signal is altered so that the field frequency of the 3D image signal becomes equal to the illumination frequency. However, for example, the following configuration may be employed: the field frequency of the 3D image signal is altered so that an integral multiple of the field frequency of the 3D image signal becomes equal to the illumination frequency or the field frequency of the 3D image signal becomes equal to an integral multiple of the illumination frequency.

In the description of the present exemplary embodiment, a vector of the motion image region is detected by comparing two temporally continuous images with each other, and an interpolation image is generated in response to the detected vector and the temporal distances between the two images and the interpolation image. However, for example, a configuration may be employed where two images are added to each other at a ratio responsive to the temporal distances between the two images and the interpolation image, the interpolation image is generated, and frequency conversion is performed. Alternatively, a configuration may be employed where frequency conversion is performed by reducing the number of fields by thinning.

In the description of the present exemplary embodiment, average illuminance detecting section 64 calculates the average illuminance based on the detection result of illuminance detecting circuit 47 and comparing section 65 compares the average illuminance detected by average illuminance detecting section 64 with the average illuminance threshold. However, for example, a configuration may be employed where average illuminance detecting section 64 calculates the average value of maximum illuminances of blinking illumination light or the average value of minimum illuminances and comparing section 65 compares these average values with a preset average illuminance threshold.

In the present exemplary embodiment, the following condition is set: when an inverter or the like is used as the luminaire, the blinking cycle of the illumination light is sufficiently short, and illumination flicker is hardly recognized by a user, the field frequency of the 3D image signal is not altered even if the shutter opening/closing operation of shutter glasses 50 is asynchronous to the blinking cycle of the illumination light. Similarly, the following condition is set: also when illumination light is emitted from the luminaire at a constant brightness and the illumination light does not blink, the field frequency of the 3D image signal is not altered. In the present exemplary embodiment, for example, the above-mentioned conditions can be achieved by the following configuration: light detecting section 81 detects blinking of illumination light of an illumination frequency of about 240 Hz or lower, and the field frequency of the image signal is not altered when light detecting section 81 cannot detect blinking of the illumination light. In the present exemplary embodiment, also, the following configuration may be employed: the field frequency of the 3D image signal is not altered when the blinking cycle of the illumination light is long (for example, the illumination frequency is 20 Hz or lower).

In the present exemplary embodiment, the following examples have been described:
the field frequency of the 3D image signal is altered to 100 Hz when the illumination frequency is 100 Hz and the field frequency of the 3D image signal is 120 Hz; and
the field frequency of the 3D image signal is altered to 120 Hz when the illumination frequency is 120 Hz and the field frequency of the 3D image signal is 100 Hz.
   However, the present invention is not limited to these frequencies. In the present invention, when the illumination frequency is different from the field frequency of the 3D image signal, the field frequency of the 3D image signal is altered so that the field frequency of the 3D image signal becomes equal to the illumination frequency.

In the description of the present exemplary embodiment, when the illumination frequency is different from the field frequency of the 3D image signal, video frequency converting circuit 49 alters the field frequency of the 3D image signal so that the field frequency of the 3D image signal becomes equal to the illumination frequency. Further, in the description, when the illumination frequency detected by illumination light frequency detecting circuit 48 is equal to the field frequency of the 3D image signal, video frequency converting circuit 49 does not alter the image signal and the vertical synchronizing signal. This “equal” does not mean that these frequencies are strictly equal to each other, but means that they are substantially equal to each other. Some errors and variation are allowed in a range where the above-mentioned effect can be produced.

### Second Exemplary Embodiment

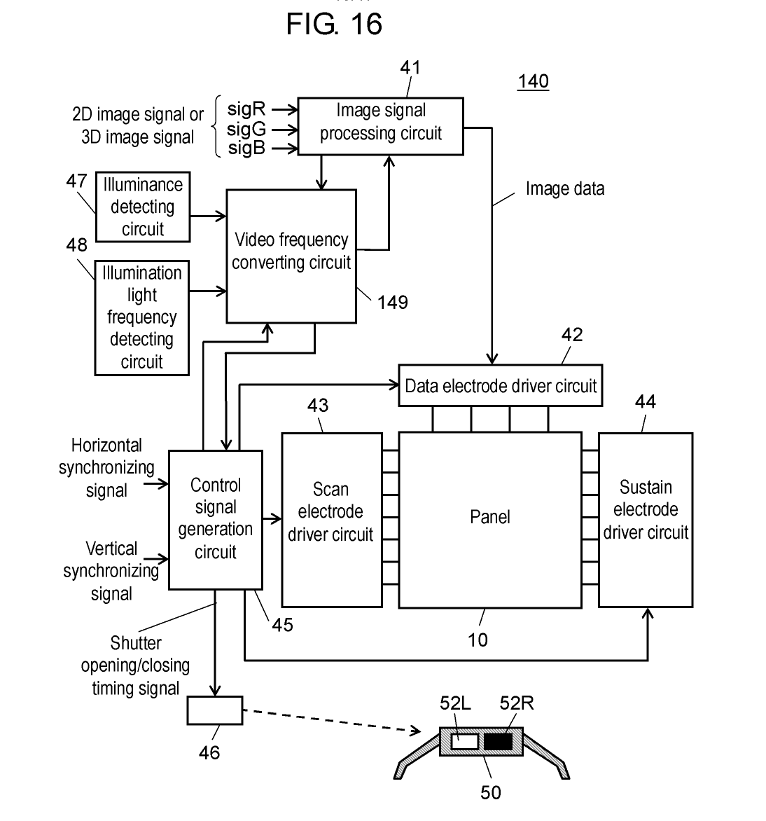

FIG. 16 is a diagram for schematically showing circuit blocks of plasma display apparatus 140 and a plasma display system in accordance with a second exemplary embodiment of the present invention. The plasma display system of the present exemplary embodiment includes, as components, plasma display apparatus 140 and shutter glasses 50.

Plasma display apparatus 140 includes panel 10 and a driver circuit for driving panel 10. The driver circuit has the following elements:
image signal processing circuit 41;
data electrode driver circuit 42;
scan electrode driver circuit 43;
sustain electrode driver circuit 44;
control signal generation circuit 45;
illuminance detecting circuit 47;
illumination light frequency detecting circuit 48;
video frequency converting circuit 149; and
a power supply circuit (not shown) for supplying power required for each circuit block.

In the second exemplary embodiment, the circuit blocks for performing the same operation as that of plasma display apparatus 40 of the first exemplary embodiment are denoted with the same reference marks, and the descriptions of those circuit blocks are omitted.

Plasma display apparatus 140 of the second exemplary embodiment has video frequency converting circuit 149 instead of video frequency converting circuit 49 of plasma display apparatus 40 of the first exemplary embodiment.

In the first exemplary embodiment, the following configuration has been described: the average illuminance detected by average illuminance detecting section 64 is compared with a preset average illuminance threshold, and, even when the illumination frequency is different from the field frequency of the 3D image signal, the field frequency is not altered when the average illuminance is lower than the average illuminance threshold. This is because illumination flicker is hardly recognized by a user when the illumination light is sufficiently dark.

Similarly, illumination flicker is hardly recognized by a user when the illuminance by light other than the illumination light is sufficiently high, for example when solar light coming through a window illuminates the interior sufficiently brightly. Therefore, video frequency converting circuit 149 of the present exemplary embodiment detects a minimum illuminance when the illumination light blinks. When the minimum illuminance is sufficiently high, video frequency converting circuit 149 does not alter the field frequency even if the illumination frequency is different from the field frequency of the 3D image signal.

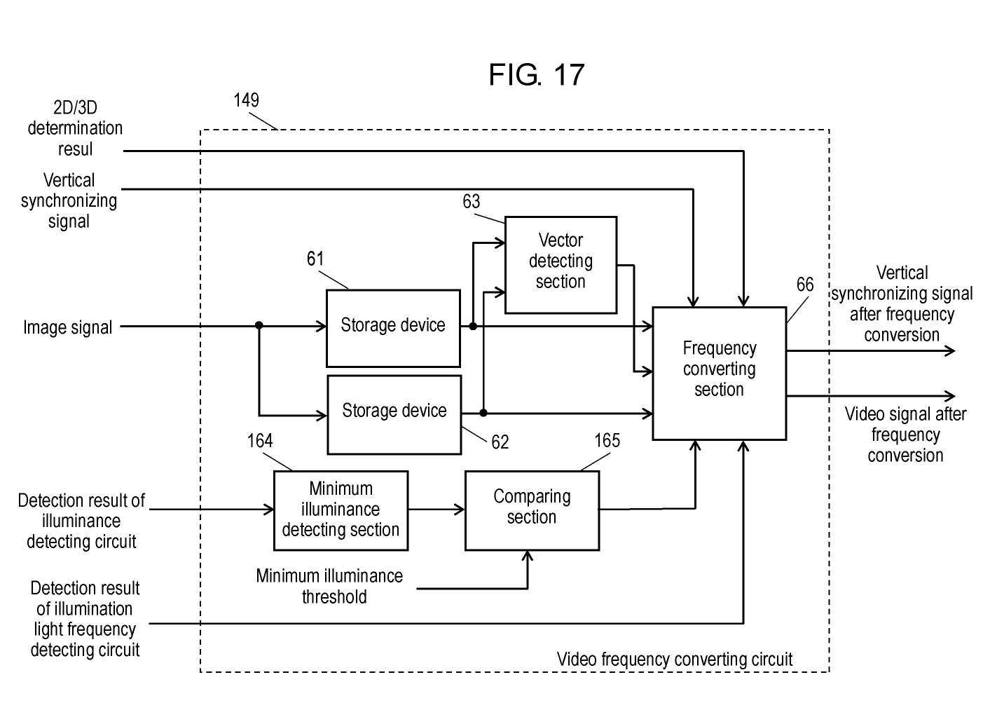

FIG. 17 is a diagram for schematically showing video frequency converting circuit 149 as an example of the circuit block of a video frequency converting circuit in accordance with the second exemplary embodiment of the present invention.

Video frequency converting circuit 149 has storage device 61, storage device 62, vector detecting section 63, frequency converting section 66, minimum illuminance detecting section 164, and comparing section 165.

In the second exemplary embodiment, the circuit blocks for performing the same operation as that of video frequency converting circuit 49 of the first exemplary embodiment are denoted with the same reference marks, and the descriptions of those circuit blocks are omitted.

When the illumination light blinks, the detection result of illuminance detecting circuit 47 varies cyclically. Using the detection result of illuminance detecting circuit 47, minimum illuminance detecting section 164 calculates, as a minimum illuminance, the average value of minimum values during the cyclic variation for a predetermined period. The predetermined period is 10 sec, for example. In the present exemplary embodiment, however, the length of the period when the minimum illuminance is calculated, is not limited to 10 sec, but may be shorter than 10 sec or may be 10 sec or longer. Preferably, the period when the minimum illuminance is calculated is set optimally in response to the specification or the like of plasma display apparatus 40.

Comparing section 165 compares the minimum illuminance detected by minimum illuminance detecting section 164 with a preset minimum illuminance threshold, determines whether the minimum illuminance is the minimum illuminance threshold or higher, and outputs the determination result. In the present exemplary embodiment, the minimum illuminance threshold is a numerical value equivalent to 1501 lux, for example. However, the numerical value of 1501 lux is simply one example, and the minimum illuminance threshold is not limited to this numerical value in the present exemplary embodiment. Preferably, the minimum illuminance threshold is set optimally in response to the specification or the like of plasma display apparatus 40.

Even when the illumination frequency is different from the field frequency of a 3D image signal, frequency converting section 66 does not alter the field frequency when the minimum illuminance is the minimum illuminance threshold or higher. Thus, when illumination flicker occurs but the illumination flicker is hardly recognized by a user, an image based on the input image signal is displayed on panel 10 and the power consumption required for converting the field frequency can be reduced.

The above-mentioned configuration and the configuration of the first exemplary embodiment may be combined.

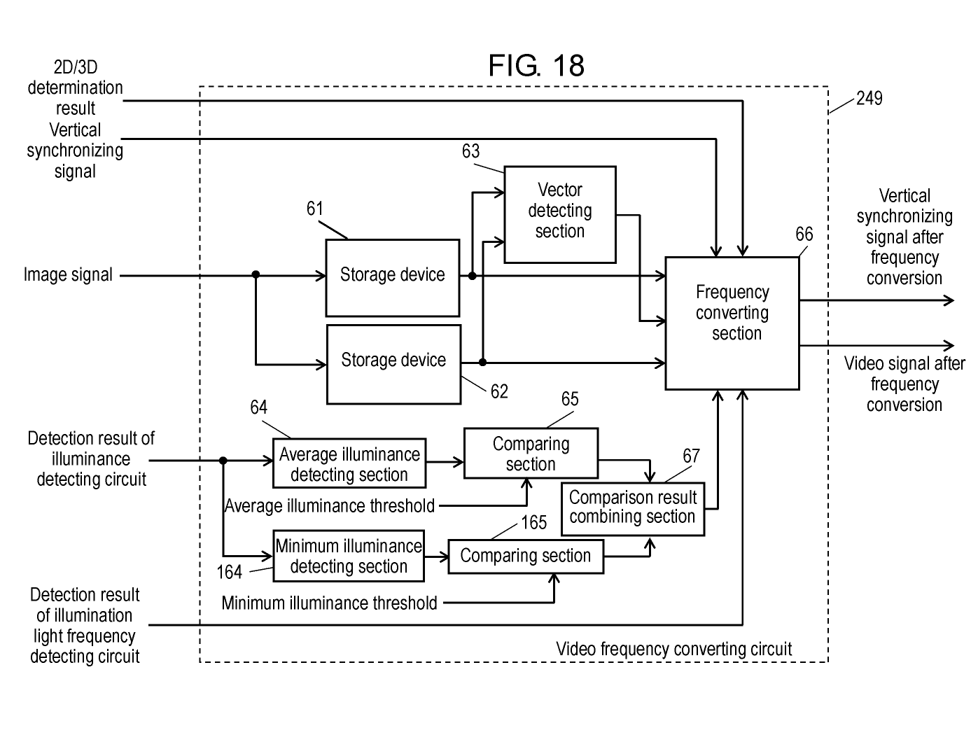

FIG. 18 is a diagram for schematically showing video frequency converting circuit 249 as another example of the circuit block of a video frequency converting circuit in accordance with the second exemplary embodiment of the present invention.

Video frequency converting circuit 249 has storage device 61, storage device 62, vector detecting section 63, frequency converting section 66, average illuminance detecting section 64, comparing section 65, minimum illuminance detecting section 164, comparing section 165, and comparison result combining section 67.

The circuit blocks for performing the same operation as that of video frequency converting circuit 49 and video frequency converting circuit 149 are denoted with the same reference marks, and the descriptions of those circuit blocks are omitted.

Comparison result combining section 67 combines the comparison result of comparing section 65 and the comparison result of comparing section 165, and outputs the combination result to frequency converting section 66.

Even when the illumination frequency is different from the field frequency of a 3D image signal, frequency converting section 66 does not alter the field frequency when the average illuminance is lower than the average illuminance threshold or the minimum illuminance is the minimum illuminance threshold or higher. Thus, when illumination flicker occurs but the illumination flicker is hardly recognized by a user, an image based on the input image signal is displayed on panel 10 and the power consumption required for converting the field frequency can be reduced.

The driving voltage waveforms shown in FIG. 4 and FIG. 5 are one example in the exemplary embodiments of the present invention, and the present invention is not limited to these driving voltage waveforms. The circuit configurations shown in FIG. 3, FIG. 8, FIG. 9, FIG. 10, FIG. 16, FIG. 17, and FIG. 18 are one example in the exemplary embodiments of the present invention, and the present invention is not limited to these circuit configurations.

FIG. 5 shows the example where down-ramp waveform voltages are generated and applied to scan electrode SC1 through scan electrode SCn in the period after the completion of subfield SF6 until the start of subfield SF1, but generation of these voltages may be omitted. For example, a configuration may be employed where scan electrode SC1 through scan electrode SCn, sustain electrode SU1 through sustain electrode SUn, and data electrode D1 through data electrode Dm are kept at 0 (V) in the period after the completion of subfield SF6 until the start of subfield SF1.

In the exemplary embodiments of the present invention, the example has been described where one field is formed of eight subfields during 2D drive and one field is formed of six subfields during 3D drive. In the present invention, however, the number of subfields constituting one field is not limited to the above-mentioned one. For example, by increasing the number of subfields, the number of gradations displayable on panel 10 can be increased.

In the exemplary embodiments of the present invention, the example has been described where respective luminance weights of subfield SF1 through subfield SF8 are set at (1, 2, 4, 8, 16, 32, 64, 128) during the 2D drive, and respective luminance weights of subfield SF1 through subfield SF6 are set at (1, 16, 8, 4, 2, 1) during the 3D drive. However, the luminance weights of respective subfields are not limited to these numerical values. For example, when respective luminance weights of subfield SF1 through subfield SF6 are set at (1, 12, 7, 3, 2, 1) during the 3D drive and the combination of the subfields for determining gradations is made flexible, coding where occurrence of a motion image false contour is suppressed is allowed. The number of subfields constituting one field and the luminance weights of respective subfields are set appropriately in response to the characteristics of panel 10 or the specification of plasma display apparatus 40.

Each circuit block shown in the exemplary embodiments of the present invention may be configured as an electric circuit for performing each operation shown in the exemplary embodiments, or may be configured using a microcomputer or the like programmed so as to perform a similar operation.

In the present embodiments, an example where one pixel is formed of discharge cells of three colors R, G, and B has been described. However, also in a panel where one pixel is formed of discharge cells of four or more colors, the configuration shown in the present embodiment can be applied and a similar effect can be produced.

Each specific numerical value shown in the exemplary embodiments of the present invention is set based on the characteristics of panel 10 having a screen size of 50 inches and having 1024 display electrode pairs 24, and is simply one example in the embodiments. The present invention is not limited to these numerical values. Numerical values are preferably set optimally in response to the characteristics of the panel or the specification of the plasma display apparatus. These numerical values can vary in a range where the above-mentioned effect can be produced. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

In an image display apparatus usable as a 3D image display apparatus of the present invention, a high-quality 3D image can be achieved by preventing a user who views a display image through the shutter glasses from sensing illumination flicker that is generated by blinking of illumination light. Therefore, the present invention is useful as an image display apparatus, an image display system, and a driving method of the image display apparatus.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35, 35R, 35G, 35B phosphor layer
40, 140 plasma display apparatus
41 image signal processing circuit
42 data electrode driver circuit
43 scan electrode driver circuit
44 sustain electrode driver circuit
45 control signal generation circuit
46 timing signal output section
47 illuminance detecting circuit
48 illumination light frequency detecting circuit
49, 149, 249 video frequency converting circuit
50 shutter glasses
52R right-eye shutter
52L left-eye shutter
61, 62 storage device
63 vector detecting section
64 average illuminance detecting section
65, 165 comparing section
66 frequency converting section
67 comparison result combining section
71, 81 light detecting section
72, 82 voltage converting section
83 frequency detecting section
164 minimum illuminance detecting section
L1, L2, L4 ramp voltage
L3 erasing ramp voltage

1. An image display apparatus comprising:
an image display section; and
a driver circuit for displaying a 3D image on the image display section by alternately repeating a right-eye field for displaying a right-eye image signal and a left-eye field for displaying a left-eye image signal based on a 3D image signal having the right-eye image signal and the left-eye image signal,
wherein the driver circuit includes:
a control signal generation circuit for generating a shutter opening/closing timing signal, the shutter opening/closing timing signal having:
a right-eye timing signal that becomes ON when the right-eye field is displayed on the image display section and becomes OFF when the left-eye field is displayed; and
a left-eye timing signal that becomes ON when the left-eye field is displayed and becomes OFF when the right-eye field is displayed;
an illumination light frequency detecting circuit for detecting a blinking cycle of illumination light as an illumination frequency; and
a video frequency converting circuit for altering a field frequency of the 3D image signal, and
wherein, in response to the illumination frequency detected by the illumination light frequency detecting circuit, the video frequency converting circuit alters the field frequency of the 3D image signal and the control signal generation circuit alters a frequency of the shutter opening/closing timing signal.

2. The image display apparatus of claim 1, wherein
when the illumination frequency detected by the illumination light frequency detecting circuit is different from the field frequency of the 3D image signal, the driver circuit alters the field frequency of the 3D image signal so that the field frequency of the 3D image signal becomes equal to the illumination frequency, and alters the frequency of the shutter opening/closing timing signal in response to the alteration of the field frequency of the 3D image signal.

3. The image display apparatus of claim 1, wherein
the driver circuit receives the 3D image signal and a 2D image signal that has no differentiation between a right-eye image signal and a left-eye image signal, and
the driver circuit alters the field frequency and the frequency of the shutter opening/closing timing signal in response to the illumination frequency only when the 3D image signal is received.

4. The image display apparatus of claim 1, wherein
the driver circuit includes an average illuminance detecting section for detecting an average illuminance of illumination light, and
when the average illuminance detected by the average illuminance detecting section is lower than an average illuminance threshold, the video frequency converting circuit does not alter of the field frequency responsive to the illumination frequency, and the control signal generation circuit does not alter the frequency of the shutter opening/closing timing signal.

5. The image display apparatus of claim 1, wherein
the driver circuit includes a minimum illuminance detecting section for detecting a minimum illuminance of illumination light, and
when the minimum illuminance detected by the minimum illuminance detecting section is equal to or higher than a minimum illuminance threshold, the video frequency converting circuit does not alter the field frequency responsive to the illumination frequency, and the control signal generation circuit does not alter the frequency of the shutter opening/closing timing signal.

6. A driving method of an image display apparatus, the driving method comprising:
detecting a blinking cycle of illumination light as an illumination frequency; and
altering a field frequency of a 3D image signal and a frequency of a shutter opening/closing timing signal in response to the illumination frequency,
wherein the image display apparatus includes
an image display section; and
a driver circuit for displaying a 3D image on the image display section by alternately repeating a right-eye field for displaying a right-eye image signal and a left-eye field for displaying a left-eye image signal based on the 3D image signal having the right-eye image signal and the left-eye image signal,
wherein the image display apparatus generates the shutter opening/closing timing signal, the shutter opening/closing timing signal having:
a right-eye timing signal that becomes ON when the right-eye field is displayed on the image display section and becomes OFF when the left-eye field is displayed; and
a left-eye timing signal that becomes ON when the left-eye field is displayed and becomes OFF when the right-eye field is displayed.

7. The driving method of the image display apparatus of claim 6, wherein
the driver circuit receives the 3D image signal and a 2D image signal that has no differentiation between a right-eye image signal and a left-eye image signal, and
the driver circuit alters the field frequency and the frequency of the shutter opening/closing timing signal in response to the illumination frequency only when the 3D image signal is received.

8. The driving method of the image display apparatus of claim 6, wherein
an average illuminance of illumination light is detected, and
when the average illuminance is lower than an average illuminance threshold, the alteration of the field frequency and the frequency alteration of the shutter opening/closing timing signal responsive to the illumination frequency are not performed.

9. The driving method of the image display apparatus of claim 6, wherein
a minimum illuminance of illumination light is detected, and
when the minimum illuminance is equal to or higher than a minimum illuminance threshold, the alteration of the field frequency and the frequency alteration of the shutter opening/closing timing signal responsive to the illumination frequency are not performed.

10. An image display system comprising:
an image display apparatus including:
an image display section; and
a driver circuit for displaying a 3D image on the image display section by alternately repeating a right-eye field for displaying a right-eye image signal and a left-eye field for displaying a left-eye image signal based on a 3D image signal having the right-eye image signal and the left-eye image signal,
wherein the driver circuit includes:
a control signal generation circuit for generating a shutter opening/closing timing signal, the shutter opening/closing timing signal having:
a right-eye timing signal that becomes ON when the right-eye field is displayed on the image display section and becomes OFF when the left-eye field is displayed; and
a left-eye timing signal that becomes ON when the left-eye field is displayed and becomes OFF when the right-eye field is displayed;
an illumination light frequency detecting circuit for detecting a blinking cycle of illumination light as an illumination frequency; and
a video frequency converting circuit for altering a field frequency of the 3D image signal; and
shutter glasses having a right-eye shutter and a left-eye shutter capable of being opened or closed independently, the opening and closing of the shutters being controlled in response to the shutter opening/closing timing signal generated by the control signal generation circuit,
wherein, in response to the illumination frequency detected by the illumination light frequency detecting circuit, the video frequency converting circuit alters the field a frequency of the 3D image signal and the control signal generation circuit alters frequency of the shutter opening/closing timing signal, and
wherein the opening and closing of the shutters of the shutter glasses are controlled in response to the shutter opening/closing timing signal whose frequency is altered.
